(19) United States
(12) Patent Application Publication
(10) Pub. No.: US 2013/0198731 A1
(43) Pub. Date: Aug. 1, 2013

(54) CONTROL APPARATUS, SYSTEM, AND METHOD

(71) Applicant: FUJITSU LIMITED, Kawasaki-shi (JP)

(72) Inventor: Yusuke INAI, Kawasaki (JP)

(73) Assignee: FUJITSU LIMITED, Kawasaki-shi (JP)

(21) Appl. No.: 13/755,000

(22) Filed: Jan. 31, 2013

(30) Foreign Application Priority Data
Feb. 1, 2012 (JP) 2012-020109

(51) Int. Cl. G06F 9/445

(52) U.S. Cl. CPC G06F 8/65
USPC 717/170

(57) ABSTRACT

In a control apparatus, a transfer control unit acquires a version number of a program from each of electronic apparatuses, and transfers an update program according to the acquired version number to one or more of the electronic apparatuses. An update control unit acquires, from each of the electronic apparatuses to which the update program has been transferred, information regarding whether the transfer of the update program by the transfer control unit has been completed successfully. Based on the acquired information, the update control unit outputs, to one or more electronic apparatuses for which the transfer of the update program has been completed successfully, an instruction for executing an update process to make a change to the update program transferred by the transfer control unit.

### CROSS-REFERENCE TO RELATED APPLICATION

This application is based upon and claims the benefit of priority of the prior Japanese Patent Application No. 2012-020109, filed on Feb. 1, 2012, the entire contents of which are incorporated herein by reference.

### FIELD

The embodiments discussed herein are related to a control apparatus, a control system, and a control method.

### BACKGROUND

Firmware incorporated in electronic apparatuses may be updated for the purpose of adding control functions, correcting bugs, and so on. In a system equipped with a large number of electronic apparatuses, it takes a long period of time to perform the operation associated with updating firmware of each of the electronic apparatuses, which imposes a high workload on an operator of the firmware update.

In view of such problems, a system has been proposed in which a server apparatus manages electronic apparatuses whose firmware is to be updated and automatically transfers a new version of firmware to each of the electronic apparatuses. In addition, there is a storage system having multiple bridges, to each of which multiple storage apparatuses are connected. One of the bridges transfers a new version of firmware not only to storage apparatuses connected thereto, but also to other bridges.
Japanese National Publication of International Patent Application No. 2005-502971
Japanese Laid-open Patent Publication No. 2004-252806

A firmware update process for an electronic apparatus includes, for example, an operation of transferring firmware to the electronic apparatus and an operation of changing firmware to be run by the electronic apparatus to the transferred firmware. In general, the latter operation includes a restart of the electronic apparatus. As for a system where a server apparatus transfers firmware to a number of electronic apparatuses, the firmware transfer operation for some of the electronic apparatuses may not be completed successfully. In such a situation, uniformly changing the firmware to be run to the transferred firmware in all of the electronic apparatuses has the potential to cause an operational error in the electronic apparatuses for which the firmware transfer operation has not completed successfully. For example, the electronic apparatuses with the failed firmware transfer may suffer from operational instability or become inoperative. This leads to unstable operation of the system.

### SUMMARY

According to one aspect, there is provided a control apparatus for performing control to update a program for each of multiple electronic apparatuses. The control apparatus includes a transfer control unit and an update control unit. The transfer control unit is configured to acquire a version number of the program from each of the multiple electronic apparatuses and transfer an update program according to the acquired version number to one or more of the multiple electronic apparatuses. The update control unit is configured to acquire, from the one or more of the multiple electronic apparatuses, information regarding whether the transfer of the update program by the transfer control unit has been completed successfully, and output, to one or more electronic apparatuses for which the transfer of the update program by the transfer control unit has been completed successfully, an instruction for executing an update process to make a change to the update program transferred by the transfer control unit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a configuration example and operation example of a control system according to a first embodiment;

FIG. 2 illustrates an overall configuration example of a storage system according to a second embodiment;

FIG. 3 illustrates a hardware configuration example of a VLP;

FIG. 4 illustrates hardware configuration examples of a disk array apparatus, a tape library apparatus, a FC switch, and a LAN switch;

FIG. 5 illustrates a configuration example of processing functions of the VLP and an example of information to which the VLP refers;

FIG. 6 is a block diagram illustrating an example of processing functions of firmware update target apparatuses;

FIG. 7 illustrates processes of a download processing unit;

FIG. 8 is a flowchart illustrating an example of a download processing procedure performed by the download processing unit;

FIG. 9 illustrates an example of information registered in reading necessity information;

FIG. 10 is a flowchart illustrating an example of a firmware transfer processing procedure performed by a transfer processing unit;

FIG. 11 illustrates an example of information registered in firmware transfer information;

FIG. 12 is a flowchart illustrating an example of a firmware transfer processing procedure for each apparatus type;

FIG. 13 is a flowchart illustrating an example of an activation control processing procedure;

FIG. 14 illustrates an example of information registered in firmware activation information;

FIG. 15 is a flowchart illustrating an example of an activation instructing processing procedure for control servers;

FIG. 16 is a flowchart illustrating an example of an activation instructing processing procedure for apparatuses other than the control servers;

FIG. 17 is a flowchart illustrating an example of a restart control processing procedure;

FIG. 18 is a flowchart illustrating an example of a restart instructing processing procedure for the control servers; and

FIG. 19 is a flowchart illustrating a restart instructing processing procedure for apparatuses other than the control servers.

### DESCRIPTION OF EMBODIMENTS

Several embodiments will be described below with reference to the accompanying drawings, wherein like reference numerals refer to like elements throughout.

### (a) First Embodiment

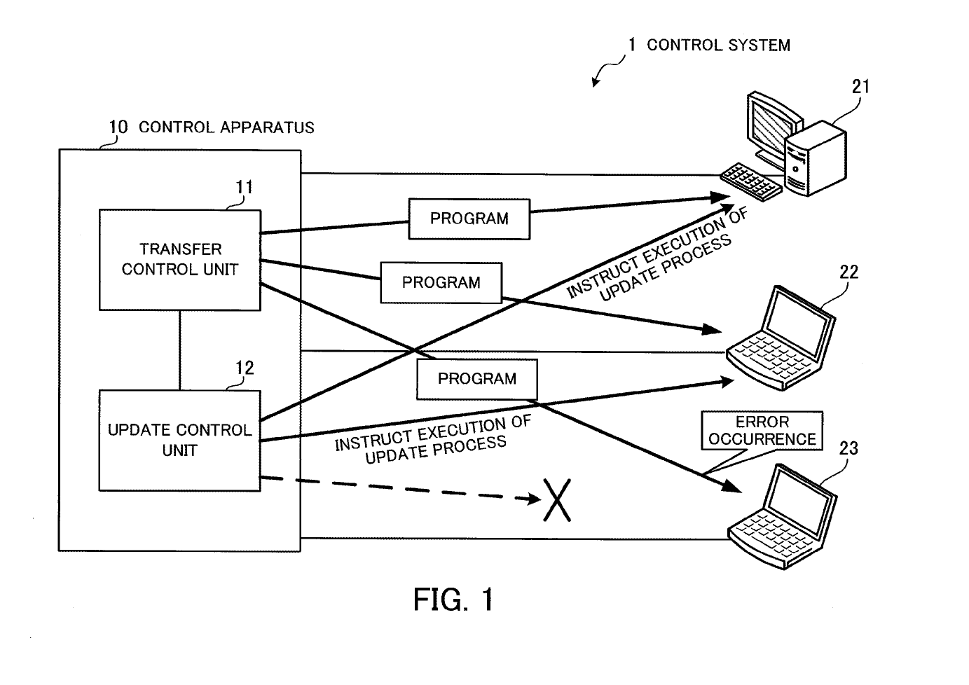

FIG. 1 illustrates a configuration example and operation example of a control system according to a first embodiment. A control system 1 includes a control apparatus and multiple electronic apparatuses 21 to 23. The electronic apparatuses 21 to 23 are computer apparatuses for implementing predetermined operations when a central processing unit (CPU) provided in each of the electronic apparatuses 21 to 23 executes a program. Note that the number of electronic apparatuses provided in the control system 1 may be arbitrarily determined, and the control system 1 may include as many as, for example, ten or more electronic apparatuses. In addition, the electronic apparatuses 21 to 23 may be connected to one another so as to cooperate with each other.

The control apparatus 10 is connected to the multiple electronic apparatuses 21 to 23, and is capable of executing a process of updating a program to be run by each of the electronic apparatuses 21 to 23. The control apparatus 10 includes a transfer control unit 11 and an update control unit 12 as processing functions for program updates.

The transfer control unit 11 acquires a version number of the program from each of the electronic apparatuses 21 to 23 and transfers an update program according to the acquired version number to one or more of the electronic apparatuses 21 to 23. For example, in the case where the version number of the program acquired from an electronic apparatus is older than the version number of the update program, the transfer control unit 11 transfers the update program to the electronic apparatus.

The update control unit 12 acquires, from each electronic apparatus to which the update program has been transferred, information indicating whether the transfer of the update program by the transfer control unit 11 has been completed successfully. Based on the acquired information, the update control unit 12 outputs, to individual electronic apparatuses for which the transfer of the update program has been completed successfully, an instruction for executing an update process in which updating to the update program transferred from the transfer control unit 11 is performed.

Assume in the example of FIG. 1 that, when the transfer control unit 11 transfers a program to each of the electronic apparatuses 21 to 23, an error occurs in the program transfer process for the electronic apparatus 23. Accordingly, the transfer process has not been completed successfully. In this case, the update control unit 12 instructs the electronic apparatuses 21 and 22, for which the transfer process has been completed successfully, to execute a program update process. With this, the electronic apparatuses 21 and 22 execute the update program newly transferred from the transfer control unit 11. In this manner, the program updates in the electronic apparatuses 21 and 22 are completed. On the other hand, the update control unit 12 does not instruct the electronic apparatus 23, for which the transfer process has not been completed successfully, to execute the program update process.

According to the above-described process, the update control unit 12 performs control in such a manner that the program update process is not executed in the electronic apparatus 23 for which the update program transfer process has not been completed successfully. With this, it is possible to reduce the possibility of an error occurring in the electronic apparatus 23 due to the program update process having been executed.

For example, if executing the program update process, the electronic apparatus 23 then runs the incomplete program transferred from the transfer control unit 11. This may cause an error in the electronic apparatus 23. For example, the electronic apparatus 23 may suffer from operational instability or become inoperative. In addition, the incompletion of the update program transfer process for the electronic apparatus 23 may be attributable to an error in the electronic apparatus 23 itself. In this case, a more serious error may occur in the electronic apparatus 23 when the electronic apparatus 23 executes the program update process. The update control unit 12 prevents the electronic apparatus 23 from executing the program update process, and, accordingly, the above-described errors are less likely to occur in the electronic apparatus 23.

In other words, based on the result of the update program transfer process for each electronic apparatus, the update control unit 12 determines, among the electronic apparatuses to each of which the update program has been transferred, one or more electronic apparatuses in which no error would occur when the program update process is executed, and causes only the determined electronic apparatuses to execute the program update process. With this, the update control unit 12 is able to maintain operational stability of the control system 1 after the execution of the program update process.

Further, according to this embodiment, the update control unit 12 detects unsuccessful completion of the update program transfer to an electronic apparatus and determines, based on the detection result, electronic apparatuses caused to execute the program update process. This allows the operational stability of the control system 1 to be maintained, without necessity for confirmation work by the operator. Accordingly, this embodiment is capable of reducing the workload of the operator engaged in the program update operation.

### (b) Second Embodiment

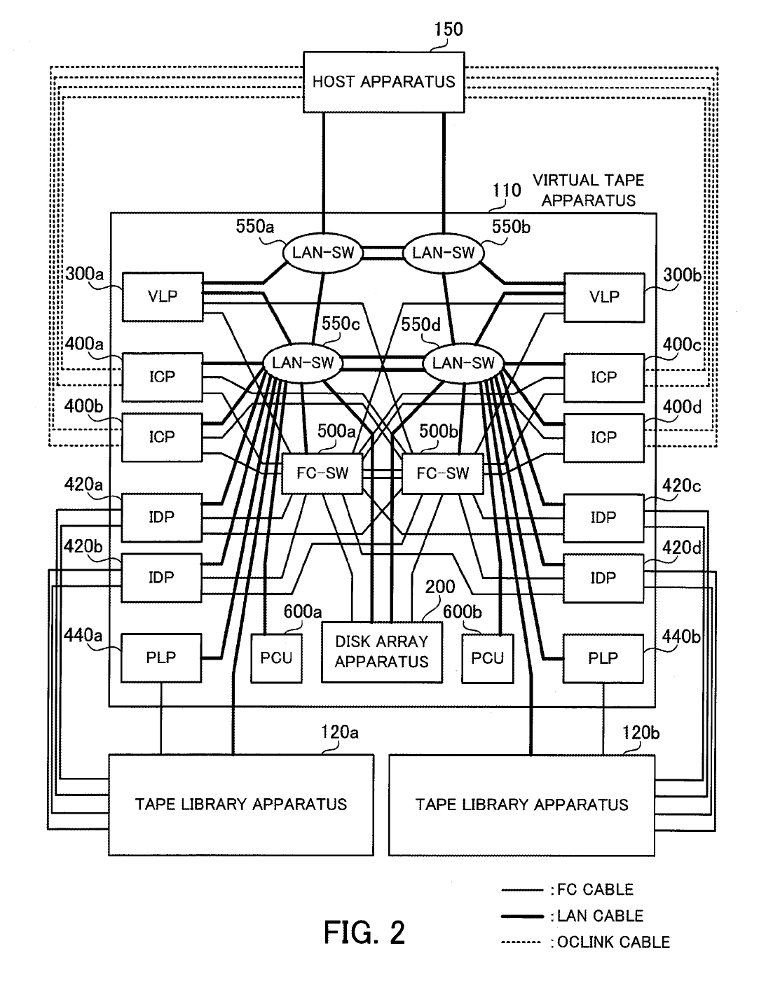

Next, a storage system is described as an example of the control system. FIG. 2 illustrates an overall configuration example of a storage system according to a second embodiment. The storage system of FIG. 2 includes a virtual tape apparatus 110 and tape library apparatuses 120a and 120b.

In each of the tape library apparatuses 120a and 120b, a number of magnetic tapes are housed. The tape library apparatuses 120a and 120b individually include, for example, one or more tape drives which perform recording and reproduction using the internally housed magnetic tapes; and a carrying mechanism for transporting magnetic tapes to the tape drives. Note that the storage system may be provided with only one tape library apparatus, or three or more tape library apparatuses.

To the virtual tape apparatus 110, a host apparatus 150 is connected. In addition, the virtual tape apparatus 110 includes a disk array apparatus 200 equipped with multiple hard disk drives (HDDs). The virtual tape apparatus 110 uses the HDDs of the disk array apparatus 200 as cache apparatuses for caching data recorded in the magnetic tapes housed in the tape library apparatuses 120a and 120b. In addition, the virtual tape apparatus 110 virtually provides, to the host apparatus 150 via the disk array apparatus 200, a large amount of storage area provided by the large number of magnetic tapes housed in the tape library apparatuses 120a and 120b.

The storage area that the virtual tape apparatus 110 virtually provides to the host apparatus 150 is hereinafter referred to as the “virtual tap drive”. In addition, a service provided by the virtual tape apparatus 110 to the host apparatus 150 and enabling access to be made from the host apparatus 150 to the virtual tape drive is referred to as “service for accessing the virtual tape drive”.

The virtual tape apparatus 110 includes, in addition to the disk array apparatus 200, virtual library processors (VLPs) 300a and 300b, integrated channel processors (ICPs) 400a to 400d, integrated device processors (IDPs) 420a to 420d, physical library processors (PLPs) 440a and 440b, fibre channels (FCs) switches 500a and 500b, local area network (LAN) switches 550a to 550d, and power control units (PCUs) 600a and 600b.

Each of the VLPs 300a and 300b, ICPs 400a to 400d, IDPs 420a to 420d, and PLPs 440a and 440b is provided as a computer. The VLPs, ICPs, IDPs, and PLPs are hereinafter collectively referred to as the “control servers”.

The ICPs 400a to 400d are control servers for controlling data transfer between the host apparatus 150 and the disk array apparatus 200 under the control of either the VLP 300a or 300b. The ICPs 400a to 400d perform communication with the host apparatus 150 via optical cables according to a standard called the Optical Channel LINK (OCLINK, registered trademark). Note that providing multiple ICPs improves the reliability of the data transfer process between the host apparatus 150 and the disk array apparatus 200.

The IDPs 420a and 420b are control servers for controlling data transfer between the disk array apparatus 200 and the tape drives installed in the tape library apparatus 120a under the control of either the VLP 300a or 300b. The IDPs 420c and 420d are control servers for controlling data transfer between the disk array apparatus 200 and the tape drives installed in the tape library apparatus 120b under the control of either the VLP 300a or 300b. Note that providing multiple IDPs associated with each tape library apparatus improves the reliability of the data transfer process between the disk array apparatus 200 and the individual tape library apparatuses 120a and 120b.

The PLP 440a is a control server for controlling a carrying mechanism (robot) for the magnetic tapes installed in the tape library apparatus 120a under the control of either the VLP 300a or 300b. The PLP 440b controls a carrying mechanism (robot) for the magnetic tapes installed in the tape library apparatus 120b under the control of either the VLP 300a or 300b.

Due to the control of the PLP 440a, a magnetic tape is mounted on a predetermined tape drive in the tape library apparatus 120a, and data access to the mounted magnetic tape is controlled by either the IDP 420a or 420b. In a similar fashion, due to the control of the PLP 440b, a magnetic tape is mounted on a predetermined tape drive in the tape library apparatus 120b, and data access to the mounted magnetic tape is controlled by either the IDP 420c or 420d.

The VLPs 300a and 300b are control servers for having integrated control over the entire virtual tape apparatus 110. In addition, the VLPs 300a and 300b receive, from the host apparatus 150, various types of processing requests including input-output (I/O) requests for the virtual tape drive, and control the disk array apparatus 200 and the remaining types of control servers of the virtual tape apparatus 110 according to the received processing requests.

For example, the VLP 300a configures a logical volume on the virtual tape drive in response to a request from the host apparatus 150. The VLP 300a receives, from the host apparatus 150, an I/O request for the configured logical volume, and controls the disk array apparatus 200 and the remaining types of control servers of the virtual tape apparatus 110 according to the received I/O request, to thereby perform an I/O process of data with respect to the logical volume. In addition, the VLP 300a performs control to cause the disk array apparatus 200 to operate as a cache apparatus (tape volume cache).

Here is described an I/O process using the VLP 300a, the ICP 400a, the IDP 420a, and the PLP 440 as an example. First, in order to write data to the logical volume, the host apparatus 150 transmits a write request to the VLP 300a and also transmits data to be written to the ICP 400a. The ICP 400a stores the received write data in the disk array apparatus 200 and notifies the VLP 300a of an address of the storage location.

At a predetermined timing after the reception of the address notification, the VLP 300a executes a control process for copying the write data stored in the disk array apparatus 200 to a magnetic tape in the tape library apparatus 120a. At this point, the PLP 440a mounts a predetermined magnetic tape on a tape drive of the tape library apparatus 120a according to an instruction from the VLP 300a. Subsequently, according to an instruction form the VLP 300a, the IDP 420a reads the write data from the disk array apparatus 200, transfers the write data to the tape drive of the tape library apparatus 120a, on which the magnetic tape is mounted, and issues a request to write the write data to the magnetic tape.

Second, in order to read data recorded in the logical volume, the host apparatus 150 transmits a data read request to the VLP 300a. The VLP 300a determines whether data requested to be read is stored in the disk array apparatus 200. If the data is stored in the disk array apparatus 200, the VLP 300a instructs the ICP 400a to read the data from the disk array apparatus 200 and transmit the read data to the host apparatus 150.

On the other hand, if the data is not stored in the disk array apparatus 200 (that is, in the case of a cache miss), the VLP 300a executes a control process for reading data from a magnetic tape and copying the read data to the disk array apparatus 200. At this point, the PLP 440a mounts the magnetic tape, on which the data to be read is recorded, on a tape drive of the tape library apparatus 120a according to an instruction from the VLP 300a. Subsequently, according to an instruction form the VLP 300a, the IDP 420a causes the tape drive of the tape library apparatus 120a, on which the magnetic tape is mounted, to output the data. The IDP 420a stores, in the disk array apparatus 200, the read data output from the tape drive and notifies the VLP 300a of an address of the storage location. On receiving the notification, the VLP 300a instructs the ICP 400a to read the data from the disk array apparatus 200 and transmit the read data to the host apparatus 150.

By performing the above-described I/O processing control, the VLP 300a causes the storage system to operate as a hierarchical storage system which uses the disk array apparatus 200 as a primary storage (tape volume cache) and the magnetic tapes of the tape library apparatus 120a as a secondary storage.

The VLP 300b also has the same processing functions as those of the VLP 300a. Providing multiple VLPs improves the reliability of processing in the virtual tape apparatus 110. In addition, each of the VLPs 300a and 300b and the host apparatus 150 are connected to each other by multiple communication paths. For example, the VLP 300a is connected to the host apparatus 150 via the LAN switch 550a while being connected to the host apparatus 150 via the LAN switches 550c and 550d. Thus, providing redundant communication paths between each VLP and the host apparatus 150 improves the reliability of processing where the virtual tape drive is used from the host apparatus 150.

The FC switches 500a and 500b individually relay data transmitted and received between control servers via FC cables. The LAN switches 550a to 550d are relay apparatuses called switching hubs, and relay data transmitted and received between control servers via LAN cables. Each of the LAN switches 550a and 550b also relays data transmitted and received between the host apparatus 150 and each VLP. In addition, the LAN switch 550c further relays data transmitted and received between a control server and the PCU 600a, and the LAN switch 550d further relays data transmitted and received between a control server and the PCU 600b.

In the virtual tape apparatus 110, a single VLP is connected to each of a single ICP, a single IDP, and the disk array apparatus 200 via multiple communication paths. For example, the VLP 300a and the ICP 400a are connected to each other via the FC switch 500a as well as via the FC switch 500b. Further, the VLP 300a and the ICP 400a are connected with each other via the LAN switch 550c. In addition, a single ICP is connected to the disk array apparatus 200 via multiple communication paths, and a single IDP is also connected to the disk array apparatus 200 via multiple communication paths. Thus, providing redundant communication paths improves the reliability of access processing from the host apparatus 150 to virtual tape volumes.

The PCUs 600a and 600b individually convert an alternating current (AC) voltage supplied externally to a direct current (DC) voltage and supply as a power-supply voltage to each apparatus in the virtual tape apparatus 110. According to an instruction from the VLP 300a or 300b, the PCUs 600a and 600b are able to restart the individual apparatuses in the virtual tape apparatus 110 all together by temporarily stopping power supply to these apparatuses.

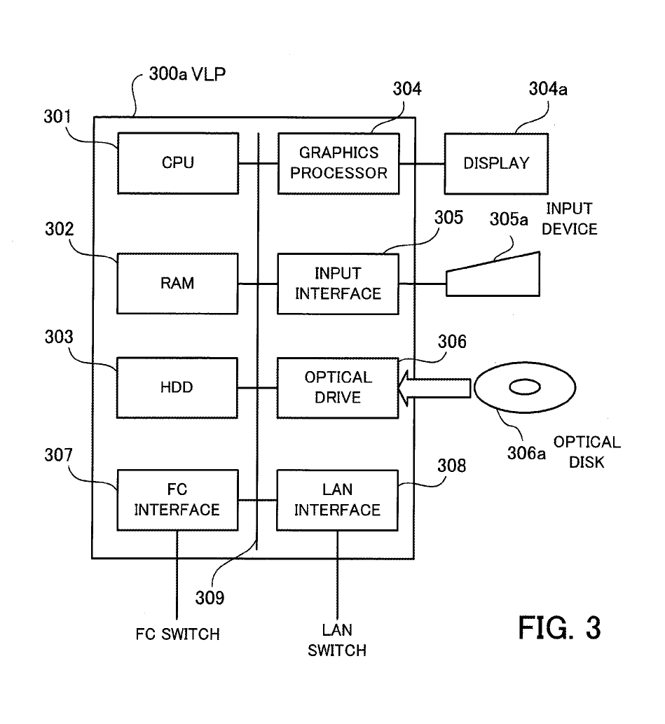

FIG. 3 illustrates a hardware configuration example of a VLP. Note that FIG. 3 illustrates the VLP 300a as an example, however, the VLP 300b also has the same hardware configuration. The entire VLP 300a is controlled by a CPU 301. To the CPU 301, a random access memory (RAM) 302 and multiple peripherals are connected via a bus 309. The RAM 302 is used as a primary storage device of the VLP 300a, and temporarily stores at least part of a program to be executed by the CPU 301 and various types of data to be used in processes implemented by the program.

The peripherals connected to the CPU 301 include, for example, a HDD (hard disk drive) 303, a graphics processor 304, an input interface 305, an optical drive 306, a FC interface 307, and a LAN interface 308.

The HDD 303 is used as a secondary storage device of the VLP 300a, and stores the program to be executed by the CPU 301 and various types of data to be used in the execution of the program. Note that, as the secondary storage device, another type of nonvolatile storage device such as a solid state drive (SSD) may be used.

To the graphics processor 304, for example, a display 304a may be connected. The graphics processor 304 causes the display 304a to display an image on its screen according to an instruction from the CPU 301. To the input interface 305, for example, an input device 305a having predetermined operation keys and the like may be connected. The input interface 305 transmits signals from the input device 305a to the CPU 301 via the bus 309. Note that at least one of the display 304a and the input device 305a may be provided in the VLP 300a.

The optical drive 306 reads data recorded on an optical disk 306a using laser light or the like. The optical disk 306a is a portable recording medium on which data is recorded in such a manner as to be read by reflection of light. Examples of the optical disk 306a include a digital versatile disc (DVD), a DVD-RAM, a compact disk read only memory (CD-ROM), a CD recordable (CD-R), and a CD rewritable (CD-RW).

The FC interface 307 is connected to other control servers via FC cables and FC switches, and transmits and receives data to and from those control servers. The LAN interface 308 is connected to other control servers and the host apparatus 150 via LAN cables and LAN switches, and transmits and receives data to and from those connected apparatuses.

Note that each of the ICPs 400a to 400c, the IDPs 420a to 420d, and the PLPs 440a and 440b may also be provided as a computer having the same hardware configuration as that of the VLP 300a illustrated in FIG. 3. Note however that, among the control servers, only the VLPs need to be equipped with the graphics processor 304, the input interface 305, and the optical drive 306.

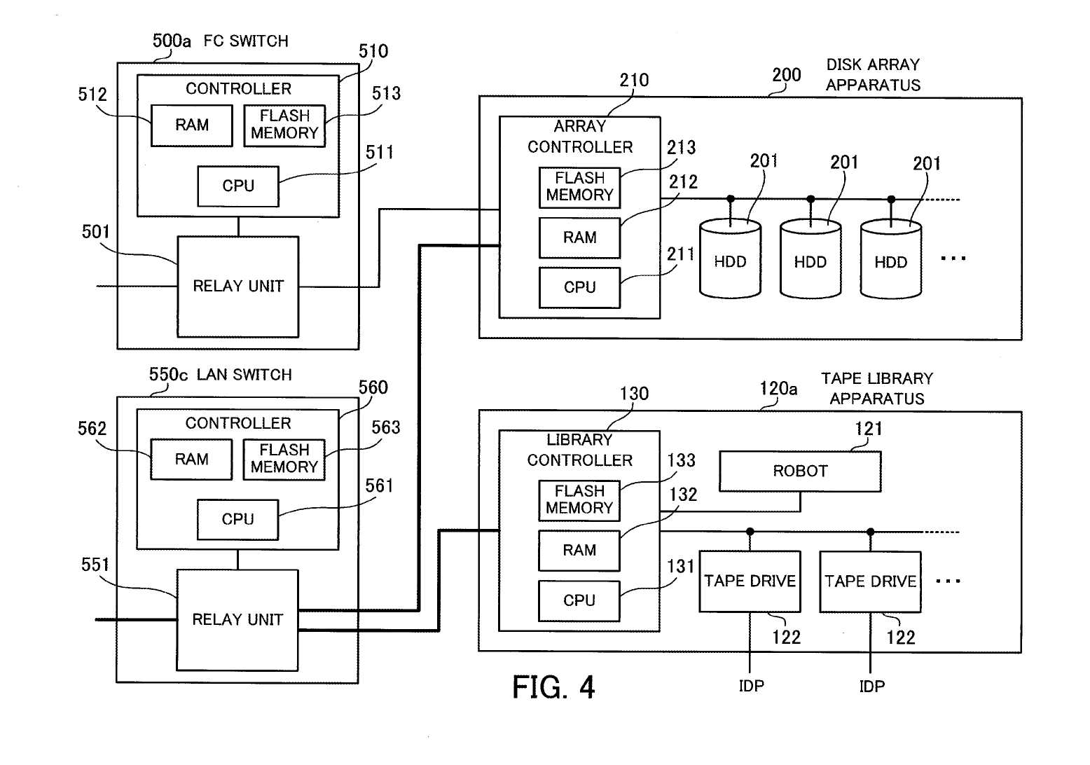

FIG. 4 illustrates hardware configuration examples of a disk array apparatus, a tape library apparatus, a FC switch, and a LAN switch. The disk array apparatus 200 includes multiple HDDs 201 and an array controller 210. A storage area provided by the multiple HDDs 201 is mainly used as a tape volume cache for caching data stored in virtual tape volumes. In addition, as described later, part of the storage area provided by the multiple HDDs 201 is used as an area dedicated for downloading firmware to be run on apparatuses of the storage system. Note that the disk array apparatus 200 may be equipped with SSDs instead of the HDDs.

The array controller 210 includes a CPU 211, a RAM 212, and a flash memory 213. The CPU 211 has integrated control over processing of the disk array apparatus 200 according to firmware stored in the flash memory 213. The RAM 212 stores at least part of the firmware to be run by the CPU 211 and data to be used in processes implemented by the firmware. In the flash memory 213, the firmware to be run by the CPU 211 and the data to be used in processes implemented by the firmware are stored in advance. Note that the CPU 211 is configured to overwrite the firmware stored in the flash memory 213 according to an instruction from the VLP 300a.

Although no illustration is given, the array controller 210 also includes, for example, a communication interface circuit for communicating according to FC standards and LAN standards; and a disk interface circuit for transmitting and receiving data to and from the HDDs 201.

The tape library apparatus 120a includes a robot 121, multiple tape drives 122, and a library controller 130. Although no illustration is given, the tape library apparatus 120a includes storage racks in which multiple magnetic tapes are stored. The robot 121 carries magnetic tapes between the storage racks and the tape drives. Each of the tape drives 122 performs recording and playback of a magnetic tape mounted by the robot 121.

The library controller 130 includes a CPU 131, a RAM 132, and a flash memory 133. The CPU 131 has integrated control over processing of the tape library apparatus 120a according to firmware stored in the flash memory 133. The RAM 132 stores at least part of the firmware to be run by the CPU 131 and data to be used in processes implemented by the firmware. In the flash memory 133, the firmware to be run by the CPU 131 and the data to be used in processes implemented by the firmware are stored in advance. Note that the CPU 131 is configured to overwrite the firmware stored in the flash memory 133 according to an instruction from the VLP 300a.

Although no illustration is given, the library controller 130 also includes, for example, a communication interface circuit for communicating according to LAN standards, a drive interface circuit for transmitting and receiving data to and from the tape drives 122, an interface circuit for transmitting a control signal to the robot 121. In addition, the tape library apparatus 120b also has the same hardware configuration as that of the tape library apparatus 120a of FIG. 4.

The FC switch 500a includes a relay unit 501 and a controller 510. The relay unit 501 includes multiple communication ports (not illustrated), to each of which a FC cable is connected, and relays data among the communication ports under the control of the controller 510.

The controller 510 includes a CPU 511, a RAM 512, and a flash memory 513. The CPU 511 has integrated control over processing of the FC switch 500a according to firmware stored in the flash memory 513. The RAM 512 stores at least part of the firmware to be run by the CPU 511 and data to be used in processes implemented by the firmware. In the flash memory 513, the firmware to be run by the CPU 511 and the data to be used in processes implemented by the firmware are stored in advance. Note that the CPU 511 is configured to overwrite the firmware stored in the flash memory 513 according to an instruction from the VLP 300a.

The LAN switch 550c includes a relay unit 551 and a controller 560. The relay unit 551 includes multiple communication ports (not illustrated), to each of which a LAN cable is connected, and relays data among the communication ports under the control of the controller 560.

The controller 560 includes a CPU 561, a RAM 562, and a flash memory 563. The CPU 561 has integrated control over processing of the LAN switch 550a according to firmware stored in the flash memory 563. The RAM 562 stores at least part of the firmware to be run by the CPU 561 and data to be used in processes implemented by the firmware. In the flash memory 563, the firmware to be run by the CPU 561 and the data to be used in processes implemented by the firmware are stored in advance. Note that the CPU 561 is configured to overwrite the firmware stored in the flash memory 563 according to an instruction from the VLP 300a.

Next described is a firmware update process performed in the storage system. As illustrated in FIG. 2, the storage system is equipped with a large number of apparatuses. Because of this, a long period of time is needed for an operation of updating firmware of all the apparatuses in the storage system. For example, the operation of updating firmware of an apparatus includes a process in which an update target apparatus reads a new version of firmware from an optical disk or the like; and a process in which the apparatus is restarted after completing the reading of the new firmware. In addition, if an apparatus has an area for storing multiple versions of firmware, the apparatus also needs to perform a process of “firmware activation” for designating, before restart of the apparatus, firmware to be run after the restart.

If a maintenance personnel carries out the update operation including these processes for the storage system with a large number of apparatuses, a period of time as long as a few hours is to be taken. In addition, during the update operation, the service operation for accessing the virtual tape drive is stopped, which prevents the host apparatus 150 from accessing the virtual tape drive. Therefore, the update operation that takes a long period of time also degrades the quality of the service for access to the virtual tape drive. In addition, the above-described update operation is not necessarily completed successfully for all the apparatuses. If firmware is updated for only some update target apparatuses and is not updated for other update target apparatuses having an error, the storage system may experience a malfunction due to the firmware inconsistency. As a result, the maintenance personnel needs to determine whether firmware is properly updated with respect to each apparatus during or after the update operation, which imposes a heavy burden on the maintenance personnel.

In addition, even when firmware is updated for only some update target apparatuses, the storage system may not experience a malfunction. The operation of the storage system may be resumed without a malfunction if measures are taken, for example, causing all of a specific type of apparatuses, or specific different types of apparatuses, to run pre-update firmware. In such a case, the operation stop time of the storage system is reduced if the operation of the storage system is resumed while some apparatuses keep running an older version of firmware. In addition, the operation of the storage system may be resumed by, for example, shutting down apparatuses whose firmware is not updated.

However, in order to resume the operation of the storage system even when errors occur in some apparatuses during the update operation, the maintenance personnel needs not only to determine the apparatuses experiencing errors, but also to determine apparatuses on which pre-update firmware is to be run or apparatuses to be shut down, according to the circumstances of the error occurrence. Such a determination process becomes more burdensome as the number of apparatuses increases.

In view of the above-mentioned problems, the VLP 300a of this embodiment has a function of centrally managing firmware to be run on individual apparatuses of the storage system, transferring firmware to each apparatus to be subjected to a firmware update, and automatically changing firmware to be run. The VLP 300a reads, from an optical disk, the latest version of firmware to be run on each update target apparatus and stores the read firmware in a specified area of the disk array apparatus 200. In addition, the VLP 300a identifies each apparatus to be subjected to a firmware update, then reads firmware to be run on the identified apparatus from the disk array apparatus 200, and transfers the read firmware to the update target apparatus. Subsequently, after causing the update target apparatus, for which the transfer has been completed, to execute an activation process if needed, the VLP 300a causes the update target apparatus to restart. In addition, the VLP 300a examines whether processing has been successfully completed in each of the firmware transfer process, the activation process, and the restart process. Based on the examination outcome of each process, the VLP 300a identifies one or more apparatuses subject to the subsequent process. These processes of the VLP 300a allow the operation of the storage system to be resumed in a short amount of time without causing a malfunction of the storage system.

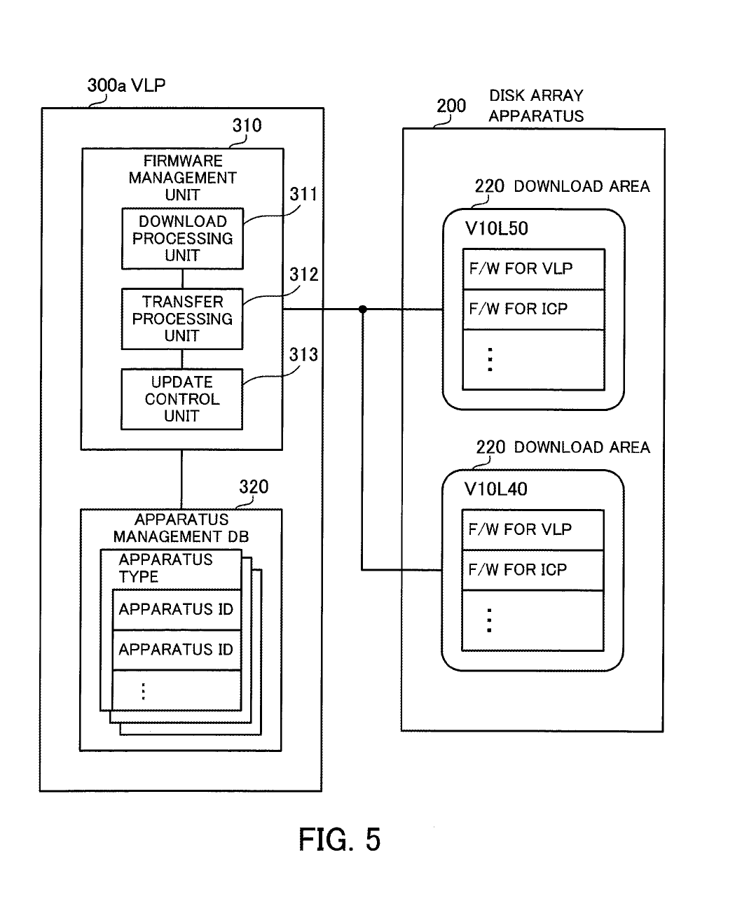

FIG. 5 illustrates a configuration example of processing functions of a VLP and an example of information to which the VLP refers. The VLP 300a includes a firmware management unit 310. Processes of the firmware management unit 310 are implemented, for example, by the CPU 301 of the VLP 300a executing a predetermined program (firmware). The firmware management unit 310 centrally manages firmware to be run on individual apparatuses of the storage system and executes a series of processes to update firmware to be run on the individual apparatuses.

In addition, the firmware management unit 310 is configured to refer to an apparatus management database (DB) 320. The apparatus management DB 320 is stored, for example, in the HDD 303 of the VLP 300a. In the apparatus management DB 320, basic information on all apparatuses possible to be firmware update targets is registered.

For example, the apparatus management DB 320 includes entries for individual types of apparatuses installed in the storage system. A type of apparatus is information to identify one of the following apparatus types: “VLP”, “ICP”, “IDP”, “PLP”, “disk array apparatus”, “FC switch”, “LAN switch”, and “tape library apparatus”. In each entry, for example, an apparatus identifier (ID) for identifying an apparatus of a corresponding type is registered. For example, in the case where individual apparatuses of the storage system are installed in slots provided in racks, each apparatus ID may be location information of a slot in which a corresponding apparatus is installed. Alternatively, each apparatus ID may be an address on a network. Note however that, in the latter case, an apparatus ID corresponding to each of the FC switches and LAN switches may be, for example, identification information uniquely given to the corresponding apparatus. In the case where multiple apparatuses of the same type are installed in the storage system, multiple apparatus IDs are registered in an entry corresponding to the type. According to the example of FIG. 2, since the four ICPs 400a to 400d are installed, apparatus IDs, each of which corresponds to one of the ICPs 400a to 400d, are registered in an entry for the apparatus type of “ICP”.

The firmware management unit 310 generates two download areas 220 in a storage area provided by one or more of the HDDs 201 of the disk array apparatus 200. In the download areas 220, actual data sets of firmware supporting all types of apparatuses possible to be firmware update targets are stored. To the download areas 220, unified version numbers are given in the order that the download areas 220 are generated. According to the example of FIG. 5, a unified version number “V10L50” is given to the upper download area 220, and a unified version number “V10L40” is given to the lower download area 220. In this case, the upper download area 220 has been generated later than the lower download area 220. Firmware of the latest version is stored in, of the two download areas 220, the area having the newer unified version number.

The firmware management unit 310 includes a download processing unit 311, a transfer processing unit 312, and an update control unit 313. The download processing unit 311 secures a download area 220 in the disk array apparatus 200 and stores, in the newly secured download area 220, firmware read from the optical disk 306a using the optical drive 306 of the VLP 300a. The transfer processing unit 312 reads firmware from the download area 220 with the latest unified version number attached, and transfers the firmware to update target apparatuses. The update control unit 313 executes, on apparatuses for which the firmware transfer has been completed, a process of changing firmware to be run to the transferred firmware. Note that communication between the firmware management unit 310 and a different apparatus in the storage system is achieved via the LAN interface 308.

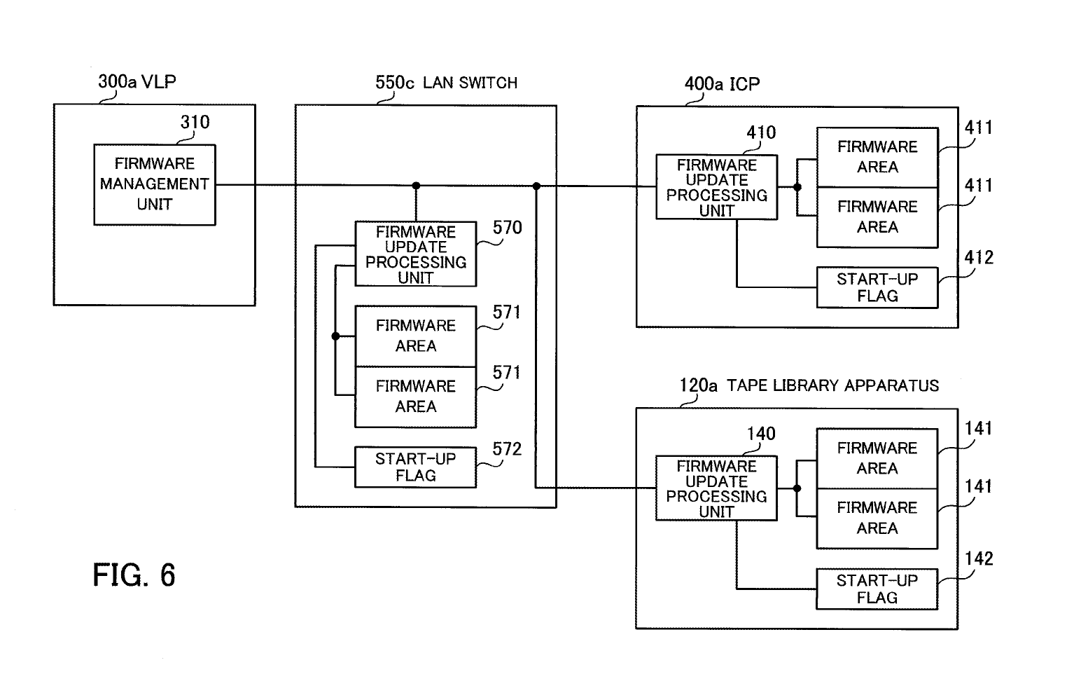

FIG. 6 is a block diagram illustrating an example of processing functions of firmware update target apparatuses. FIG. 6 illustrates by an example that the ICP 400a, the tape library apparatus 120a, and the LAN switch 550c are update target apparatuses. The ICP 400a includes a firmware update processing unit 410. Processes of the firmware update processing unit 410 are implemented by a CPU of the ICP 400a executing a predetermined program (firmware). The firmware update processing unit 410 executes processes to change firmware to be run by the CPU of the ICP 400a to firmware with a new version according to an instruction from the firmware management unit 310 of the VLP 300a.

Assume here that, in this embodiment, two firmware areas 411 each of which stores a different version of firmware are provided in a HDD of the ICP 400a. In addition, in the HDD of the ICP 400a, a start-up flag 412 is recorded that indicates which firmware of the two firmware areas 411 is to be run. A CPU of the ICP 400a reads the start-up flag 412 before running firmware on each startup in response to a power-on operation and each restart. The CPU of the ICP 400a reads firmware from one of the two firmware areas 411, indicated by the start-up flag 412. Firmware stored in one of the two firmware areas 411 is currently being run by the CPU of the ICP 400a. Accordingly, at this point, the start-up flag 412 has a value indicating a firmware area 411 in which the firmware currently being run is stored.

When carrying out a firmware update, the firmware update processing unit 410 stores firmware with a new version, transferred from the VLP 300a, in the other firmware area 411. After storing the firmware in the other firmware area 411, the firmware update processing unit 410 overwrites the start-up flag 412 in such a manner as to indicate the other firmware area 411 according to an instruction form the firmware management unit 310 of the VLP 300a. Subsequently, the ICP 400a restarts according to an instruction from the firmware management unit 310 of the VLP 300a. The CPU of the ICP 400a after the restart runs the firmware with the new version according to the start-up flag 412. With this, firmware run by the CPU of the ICP 400a is changed, and the firmware update process is completed. The above-described process of updating the start-up flag 412 after firmware with a new version is stored in one of the firmware areas 411 is referred to as the “activation” of the stored firmware.

In the example of this embodiment, each of the ICPs 400b to 400d includes the firmware update processing unit 410, the two firmware areas 411, and the start-up flag 412, as in the case of the ICP 400a. With respect to each of the remaining apparatuses of the storage system, the same functions as those of the firmware update processing unit 410 are provided. In addition, in a nonvolatile storage device, the same areas as those of the two firmware areas 411 are provided and the start-up flag 412 is recorded. Accordingly, all the apparatuses of the storage system need to carry out “activation” for updating the start-up flag during the period between the read-in of firmware with a new version and the restart of themselves.

For example, the tape library apparatus 120a includes a firmware update processing unit 140. Processes of the firmware update processing unit 140 are implemented by the CPU 131 of the tape library apparatus 120a executing a predetermined program (firmware). In addition, two firmware areas 141 each of which stores a different version of firmware are provided in the flash memory 133 of the tape library apparatus 120a. Also in the flash memory 133 of the tape library apparatus 120a, a start-up flag 142 is recorded that indicates which firmware of the two firmware areas 141 is to be run.

Similarly, for example, the LAN switch 550c includes a firmware update processing unit 570. Processes of the firmware update processing unit 570 are implemented by the CPU 561 of the LAN switch 550c executing a predetermined program (firmware). In addition, two firmware areas 571 each of which stores a different version of firmware are provided in the flash memory 563 of the LAN switch 550c. Also in the flash memory 563 of the LAN switch 550c, a start-up flag 572 is recorded that indicates which firmware of the two firmware areas 571 is to be run.

Note that at least one or more apparatuses of the storage system may have, for example, only one firmware area for storing firmware. These apparatuses do not have a start-up flag. When such an apparatus restarts after firmware in the firmware area is overwritten, a CPU of the apparatus runs the replaced firmware. That is, the apparatus does not need firmware activation at the time of a firmware update.

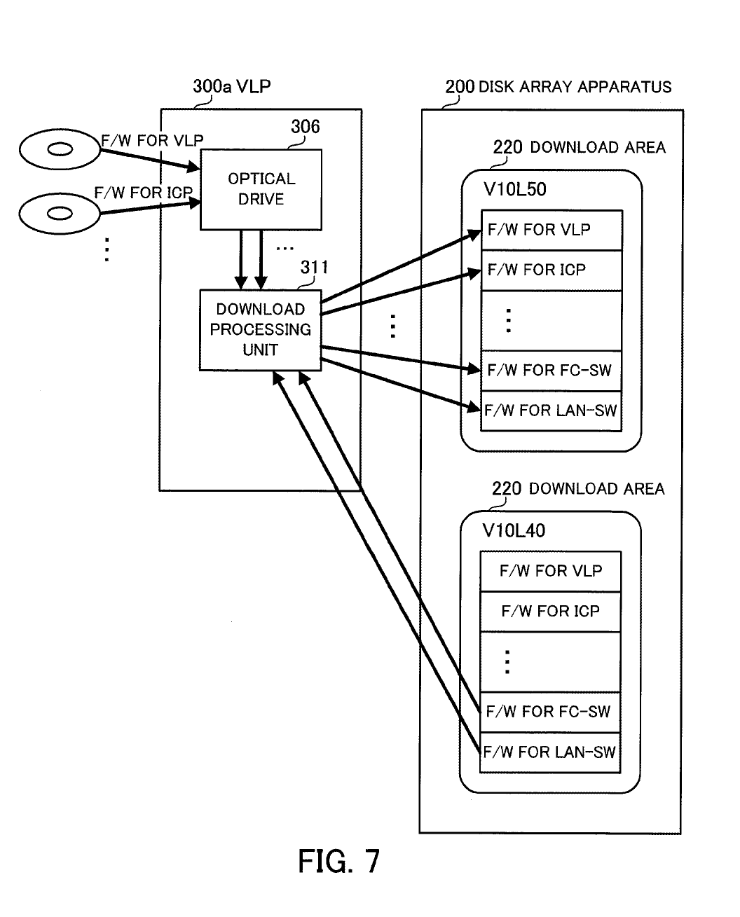

Processes of individual units included in the firmware management unit 310 are described next in detail. FIG. 7 illustrates processes of a download processing unit. The download processing unit 311 collectively manages firmware with the latest version for all the apparatuses included in the storage system, using one of the two download areas 220 of the disk array apparatus 200.

More specifically, the download processing unit 311 starts according to an input operation performed by a user, at the time of updating firmware for at least one type of apparatus, or apparatuses, of the storage system. The download processing unit 311 secures, in the disk array apparatus 200, a download area 220 to which a new unified version number is given. In the example of FIG. 7, while firmware stored in the download area 220 with the unified version number “V10L40” is being run on one or more corresponding apparatuses, the download processing unit 311 secures the download area 2200 with the new unified version number “V10L50”. Note that, at this point, the download processing unit 311 deletes a download area 220 whose unified version number is older than the unified version number “V10L40”.

Next, the download processing unit 311 stores, in the secured download area 220, firmware with the latest versions for all types of the apparatuses. The download processing unit 311 reads the firmware with the latest versions from optical disks using the optical drive 306 and stores the read firmware in the newly secured download area 220.

Note however that versions of firmware for all types of the apparatuses are not necessarily updated all together. The download processing unit 311 reads, from the download area 220 with the older unified version number, firmware corresponding to an apparatus for which firmware with a new version is not provided, and stores the firmware in the newly secured download area 220.

FIG. 7 illustrates a case in which only firmware for the control servers is updated. In this case, the download processing unit 311 reads firmware with new versions for the apparatus types of “VLP”, “ICP”, “IDP” and “PLP” from optical disks using the optical drive 306, and stores the read firmware in the newly secured download area 220 with the unified version number “V10L50”. On the other hand, the download processing unit 311 reads, from the download area 220 with the unified version number “V10L40”, firmware for the apparatus types of “disk array apparatus”, “tape library apparatus”, “FC switch”, and “LAN switch”, for each of which firmware with a new version is not provided. Subsequently, the download processing unit 311 stores the read firmware in the download area 220 with the unified version number “V10L50”.

By the above-described processes of the download processing unit 311, firmware with the latest versions is stored in the download area 220 with a newer unified version number attached, which improves the efficiency of the firmware management. When transferring firmware with a new version to an update target apparatus, the firmware management unit 310 of the VLP 300a is able to read appropriate firmware from the download area with the newer unified version number attached. This eliminates the need to read firmware with a new version from an optical disk each time before transferring the firmware. As a result, it is possible to reduce the time to be taken for the entire processes of reading firmware from optical disks and transferring it to update target apparatuses.

In addition, the download processing unit 311 secures the download areas 220 in the disk array apparatus 200 which is a storage apparatus having a large storage capacity, already existing in the storage system. This eliminates the need to add a storage apparatus dedicated for the download areas 220. Accordingly, the download processing unit 311 is able to collectively manage firmware, effectively using resources in the storage system.

Note that the above-described processes of the download processing unit 311 may be executed in parallel with the process of accessing the virtual tape drive in response to a request from the host apparatus 150. On the other hand, as described later, the service operation for accessing the virtual tape drive is stopped during the process of transferring firmware from the download area 220 to an update target apparatus. According to this embodiment, the process of reading firmware from optical disks and the process of transferring the firmware to update target apparatuses are isolated from each other. The firmware management unit 310 collectively executes the former process with respect to all apparatuses that need the former process before executing the latter process. As a result, it is possible to reduce the time of stopping the service operation for accessing the virtual tape drive.

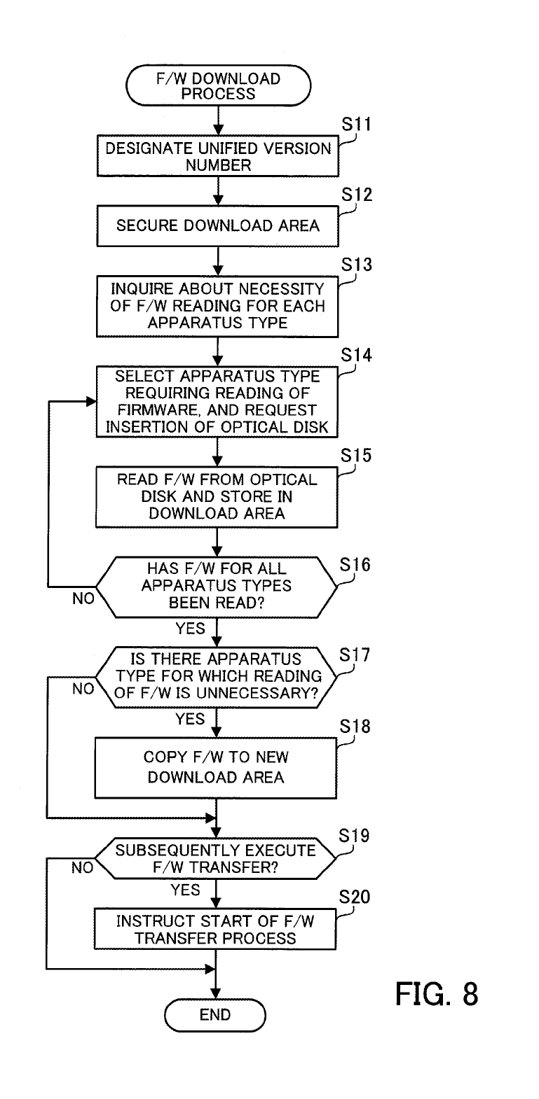

FIG. 8 is a flowchart illustrating an example of a download processing procedure performed by a download processing unit. The process of FIG. 8 is executed, for example, in response to a process start instruction from a maintenance personnel, received via the input device 305a of the VLP 300a.

[Step S11] The download processing unit 311 designates a unified version number of a download area 220 to be newly generated. For example, the download processing unit 311 receives a designation of the unified version number in accordance with an input operation of the maintenance personnel. Alternatively, the download processing unit 311 itself may designate the unified version number.

[Step S12] The download processing unit 311 secures a new download area 220 corresponding to the unified version number designated in step S11 in the storage area provided by the HDDs in the disk array apparatus 200. At this point, the download processing unit 311 deletes, of two download areas 220 existing before step S12, a download area 220 with an older unified version number.

[Step S13] The download processing unit 311 causes the display 304a to display, with respect to each type of the apparatuses included in the storage system, display information for inquiring whether to read firmware with a new version from an optical disk. The maintenance personnel provides, with respect to each apparatus type, an input indicating whether to read firmware with a new version from an optical disk. The download processing unit 311 temporarily records reading necessity information in the RAM 302 and registers, in the reading necessity information, necessity or non-necessity of new firmware reading based on the input information.

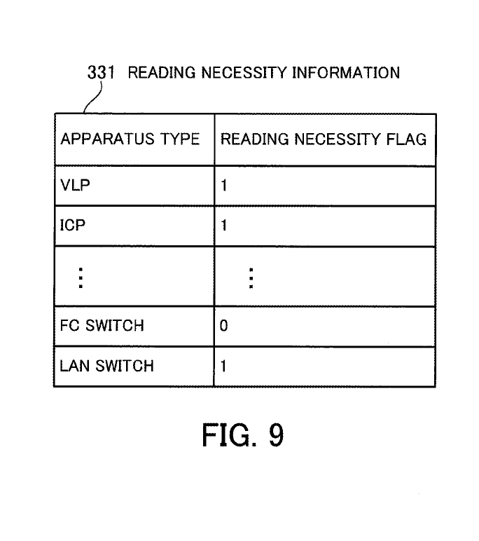

FIG. 9 illustrates an example of information registered in the reading necessity information. In reading necessity information 331, a reading necessity flag which indicates whether to read new firmware from an optical disk is registered with respect to each type of the apparatuses included in the storage system. For example, the value of the reading necessity flag is set to “1” when new firmware needs to be read, and the value of the reading necessity flag is set to “0” when new firmware does not need to be read.

The description refers back to FIG. 8.

[Step S14] The download processing unit 311 selects, from the reading necessity information 331, one apparatus type whose reading necessity flag is “1” (that is, an apparatus type which needs reading of firmware with a new version). The download processing unit 311 causes the display 304a to display display information for requesting insertion of an optical disk, in which firmware with a new version corresponding to the selected apparatus type is stored, into the optical drive 306.

[Step S15] When recognizing the insertion of an optical disk into the optical drive 306, the download processing unit 311 reads firmware from the inserted optical disk. The download processing unit 311 transmits the read firmware to the disk array apparatus 200, for example, through the LAN interface 308, and stores the firmware in the download area 220 secured in step S12.

[Step S16] The download processing unit 311 determines whether firmware has been read from an optical disk with respect to all the apparatus types whose reading necessity flag is “1” in the reading necessity information 331. If there is an apparatus type for which firmware has yet to be read (S16: No), the download processing unit 311 returns to step S14 and selects one apparatus type for which firmware has yet to be read. On the other hand, if firmware has been read for all the apparatus types whose reading necessity flag is “1” (S16: Yes), the download processing unit 311 proceeds to step S17.

[Step S17] The download processing unit 311 determines whether there is an apparatus type whose reading necessity flag is “0” in the reading necessity information 331. If there is an apparatus type whose reading necessity flag is “0” (S17: Yes), the download processing unit 311 proceeds to step S18. On the other hand, if there is no apparatus type whose reading necessity flag is “0” (S17: No), the download processing unit 311 proceeds to step S19. In the latter case, firmware with the latest versions corresponding to all the apparatus types is stored in the download area 220 generated in step S12.

[Step S18] The download processing unit 311 reads firmware corresponding to the apparatus type whose reading necessity flag is “0” from, of the two download areas 220 in the disk array apparatus 200, the download area 220 with an older unified version number. The download processing unit 311 copies the read firmware to the download area 220 newly generated in step S12. With this, firmware with the latest versions corresponding to all the apparatus types is stored in the download area 220 generated in step S12.

[Step S19] The download processing unit 311 causes the display 304a to display display information for inquiring whether to subsequently execute a process of transferring the firmware to apparatuses. If it is instructed by an input operation of the maintenance personnel to subsequently execute a firmware transfer process (S19: Yes), the download processing unit 311 proceeds to step S20. On the other hand, if it is instructed not to subsequently execute the firmware transfer process (S19: No), the download processing unit 311 ends the process.

[Step S20] The download processing unit 311 instructs the transfer processing unit 312 to start the firmware transfer process.

Next described is a process performed by the transfer processing unit 312. The transfer processing unit 312 transfers firmware from the download area 220 with a new unified version number attached, provided in the disk array apparatus 200, to a firmware area of each corresponding apparatus. In addition, each time transferring firmware to an apparatus, the transfer processing unit 312 stores, in the RAM 302, a transfer result indicating whether the transfer has been completed successfully.

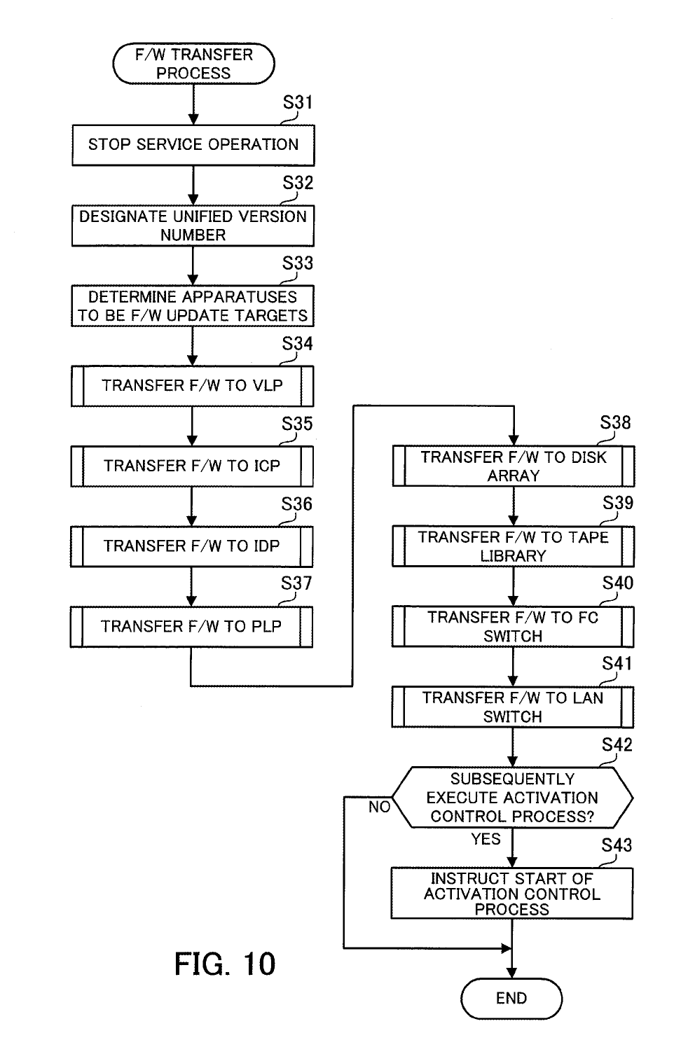

FIG. 10 is a flowchart illustrating an example of a firmware transfer processing procedure performed by a transfer processing unit. The transfer processing unit 312 executes the process of FIG. 10 when instructed by the download processing unit 311 to start the firmware transfer process in step S20 of FIG. 8, or when instructed by an input operation of the maintenance personnel to start the firmware transfer process.

[Step S31] The transfer processing unit 312 stops the service operation for accessing the virtual tape drive. For example, the transfer processing unit 312 causes its own apparatus (the VLP 300a) to stop receiving I/O requests from the host apparatus 150, to thereby stop the service operation for accessing the virtual tape drive. Alternatively, the transfer processing unit 312 may cause each apparatus in the storage system to stop a process pertaining to access to the virtual tape drive.

In such a manner, by stopping the service operation for accessing the virtual tape drive before transferring firmware to apparatuses, it is possible to prevent situations where, for example, a failure occurs in an apparatus due to an error in writing firmware to the firmware area, which in turn causes an error in the process of accessing the virtual tape drive. Note that the service operation for accessing the virtual tape drive may be stopped at any point of time before firmware transfer in step S34 is performed.

[Step S32] The transfer processing unit 312 causes the display 304a to display display information for requesting the maintenance personnel to input a unified version number of the download area 220 in which firmware to be used for update is stored. The transfer processing unit 312 receives an input of a unified version number and designates the unified version number as a processing target. Note that, instead of receiving an input of a unified version number, the transfer processing unit 312 may designate, as a processing target, a newer unified version number which has been given to one of the two download areas 220.

[Step S33] The transfer processing unit 312 generates firmware transfer information in the RAM 302. The transfer processing unit 312 determines apparatuses to be firmware update targets and registers the determination result in the firmware transfer information.

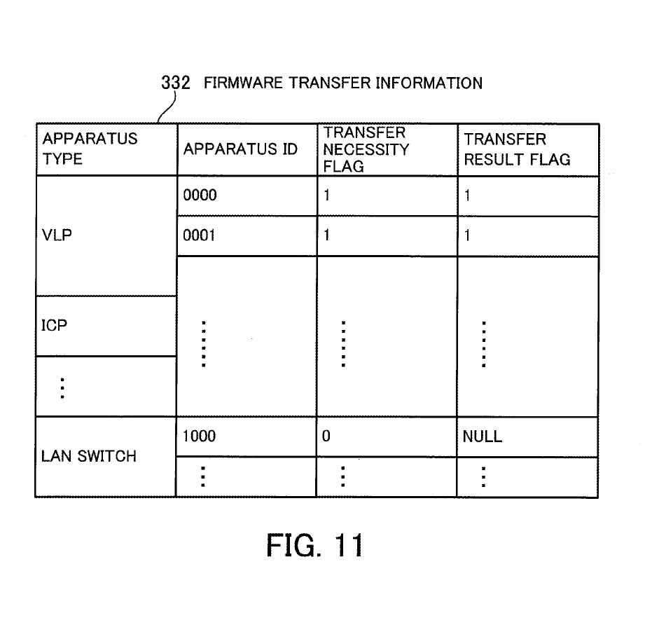

FIG. 11 illustrates an example of information registered in firmware transfer information. In firmware transfer information 332, each transfer necessity flag and transfer result flag are registered in association with an apparatus type and an apparatus ID. In step S32 of FIG. 10, the transfer processing unit 312 reads apparatus types and apparatus IDs from the apparatus management DB 320 and registers the read apparatus types and apparatus IDs in the firmware transfer information 332. With this, the apparatus types and apparatus IDs of all the apparatuses included in the storage system, possible to be firmware update targets, are registered in the firmware transfer information 332.

Each transfer necessity flag is flag information indicating whether to transfer firmware to a corresponding apparatus. For example, in the case of transferring firmware to an apparatus, the transfer processing unit 312 sets a corresponding transfer necessity flag to “1”, and in the case of not transferring firmware to an apparatus, the transfer processing unit 312 sets a corresponding transfer necessity flag to “0”.

Each transfer result flag is flag information indicating whether the firmware transfer process for a corresponding apparatus has been completed successfully. For example, if the firmware transfer process has been completed successfully, the transfer processing unit 312 sets the transfer result flag to “1”, and if the firmware transfer process has not been completed successfully, the transfer processing unit 312 sets the transfer result flag to “0”. Note that the transfer processing unit 312 sets the transfer result flag corresponding to an apparatus whose transfer necessity flag is “0” to neither “1” nor “0” and sets the transfer result flag to, for example, “NULL”.

Note that after the process of the transfer processing unit 312 illustrated in FIG. 10 is ended, the firmware transfer information 332 is referenced also by the update control unit 313.

The description refers back to FIG. 10. In Step S33, the transfer processing unit 312 inquires the version of the running firmware of each firmware update processing unit of all the apparatuses included in the storage system. The firmware update processing units referred here corresponds to, for example, the firmware update processing units 140, 410, and 570 of FIG. 6. The transfer processing unit 312 compares the version of firmware returned from each of the apparatuses which have received the inquiry and the version of corresponding firmware stored in the download area 220 with the unified version designated as a processing target in step S32.

If the compared version numbers match each other, the transfer processing unit 312 determines that there is no need of firmware update, and sets the transfer necessity flag associated with a corresponding apparatus in the firmware transfer information 332 to “0”. On the other hand, if the compared version numbers do not match each other, the transfer processing unit 312 determines that a firmware update need to be done, and sets the transfer necessity flag associated with a corresponding apparatus in the firmware transfer information 332 to “1”.

Subsequently, the transfer processing unit 312 executes a process of transferring firmware to each apparatus whose transfer necessity flag in the firmware transfer information 332 is “1”, with respect to each apparatus type in a set order.

[Step S34] The transfer processing unit 312 transfers firmware to VLPs whose transfer necessity flag is “1”, and stores the firmware in one of the two firmware areas provided in each of the transfer-destination VLPs.

[Step S35] The transfer processing unit 312 transfers firmware to ICPs whose transfer necessity flag is “1”, and stores the firmware in one of the two firmware areas 411 provided in each of the transfer-destination ICPs.

[Step S36] The transfer processing unit 312 transfers firmware to IDPs whose transfer necessity flag is “1”, and stores the firmware in one of the two firmware areas provided in each of the transfer-destination IDPs.

[Step S37] The transfer processing unit 312 transfers firmware to PLPs whose transfer necessity flag is “1”, and stores the firmware in one of the two firmware areas provided in each of the transfer-destination PLPs.

[Step S38] The transfer processing unit 312 transfers firmware to disk array apparatuses whose transfer necessity flag is “1”, and stores the firmware in one of the two firmware areas provided in each of the transfer-destination disk array apparatuses.

[Step S39] The transfer processing unit 312 transfers firmware to tape library apparatuses whose transfer necessity flag is “1”, and stores the firmware in one of the two firmware areas 141 provided in each of the transfer-destination tape library apparatuses.

[Step S40] The transfer processing unit 312 transfers firmware to FC switches whose transfer necessity flag is “1”, and stores the firmware in one of the two firmware areas provided in each of the transfer-destination FC switches.

[Step S41] The transfer processing unit 312 transfers firmware to LAN switches whose transfer necessity flag is “1”, and stores the firmware in one of the two firmware areas 571 provided in each of the transfer-destination LAN switches.

In each of the above-mentioned steps S34 to S40, the transfer processing unit 312 transfers firmware via the LAN interface 308. Accordingly, the firmware is transferred via some LAN switches. The transfer processing unit 312 carries out firmware transfer to the LAN switches after carrying out firmware transfer to other apparatuses. With this, it is possible to prevent situations where one or more of the LAN switches do not function normally due to an error caused by internal firmware overwrite, subsequently disabling the firmware transfer to other apparatuses.

[Step S42] The transfer processing unit 312 causes the display 304a to display display information for inquiring whether to subsequently execute an activation control process for activating the transferred firmware. If it is instructed by an input operation of the maintenance personnel to subsequently execute an activation control process (S42: Yes), the transfer processing unit 312 proceeds to step S43. On the other hand, if it is instructed not to subsequently execute the activation control process (S42: No), the transfer processing unit 312 ends the process.

[Step S43] The transfer processing unit 312 instructs the update control unit 313 to start the activation control process.

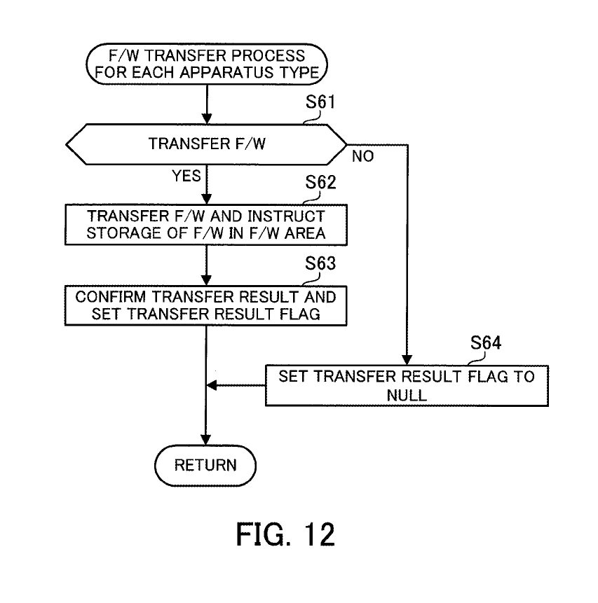

Next, a processing procedure of each of the above-mentioned steps S34 to S41 is described with reference to FIG. 12. FIG. 12 is a flowchart illustrating an example of a firmware transfer processing procedure for each apparatus type. The process of FIG. 12 is executed with respect to each apparatus type.

[Step S61] Referring to transfer necessity flags of the firmware transfer information 332, the transfer processing unit 312 determines whether, among apparatuses of a processing-target apparatus type, there is one or more apparatuses which need firmware to be transferred. If there is one or more apparatuses that need firmware to be transferred (S61: Yes), the transfer processing unit 312 proceeds to step S62. On the other hand, if there is no apparatus which needs firmware to be transferred (S61: No), the transfer processing unit 312 proceeds to step S64.

[Step S62] The transfer processing unit 312 reads firmware corresponding to the processing-target apparatus type from a download area 220 corresponding to the unified version number designated in step S32 of FIG. 10. Then, the transfer processing unit 312 transfers the read firmware to, among the apparatuses of the processing-target apparatus type, the one or more apparatuses whose transfer necessity flag is “1”. Along with this, the transfer processing unit 312 instructs the firmware update processing unit of each transfer-destination apparatus to store the transferred firmware. In each apparatus to which the firmware has been transferred, the firmware update processing unit stores, in response to the storing instruction, the received firmware in one of the two firmware areas, different from the firmware area in which currently running firmware is stored.

[Step S63] The transfer processing unit 312 confirms a transfer result with respect to each firmware transfer-destination apparatus. The transfer processing unit 312 sets, in the firmware transfer information 332, a transfer result flag corresponding to the transfer-destination apparatus to a value according to the transfer result. When the transfer process has been completed successfully, the transfer processing unit 312 sets the transfer result flag to “1”, and when the transfer process has not been completed successfully, the transfer processing unit 312 sets the transfer result flag to “0”.

Various methods may be adopted for confirming a transfer result. For example, the transfer processing unit 312 transmits, to each apparatus, firmware in which an error detection signal is attached to data of the firmware. On receiving the firmware, the firmware update processing unit of each apparatus determines, based on the attached error detection signal, whether the reception of the firmware has been completed successfully, and returns a determination result to the transfer processing unit 312. The transfer processing unit 312 is able to confirm the transfer result from the received determination result. Note that when firmware transfer has not completed successfully, the transfer processing unit 312 may transfer firmware once again to a transfer-destination apparatus, and set the transfer result flag corresponding to the transfer-destination apparatus to “0” if the second firmware transfer fails to be completed successfully.

Note that, in step S63, the transfer processing unit 312 sets, to “Null”, the transfer result flag corresponding to, among the apparatuses of the processing-target apparatus type, each apparatus that does not need firmware to be transferred.

[Step S64] The transfer processing unit 312 sets, to “Null”, the transfer result flag corresponding to each of the apparatuses of the processing-target apparatus type.

Next described is processes of the update control unit 313. The update control unit 313 continuously executes an activation control process for activating transferred firmware and a restart control process for restarting an apparatus in which firmware activation has been completed. In addition, in the activation control process, the update control unit 313 determines one or more apparatuses in which an activation process is to be executed, according to conditions provided for each apparatus type based on transfer results of the firmware transfer process. Further, in the restart control process, the update control unit 313 determines one or more apparatuses to be restarted, according to conditions provided for each apparatus type based on execution results of the activation process. These processes of the update control unit 313 prevent a process error due to an execution situation of the firmware update process from occurring in the storage system.

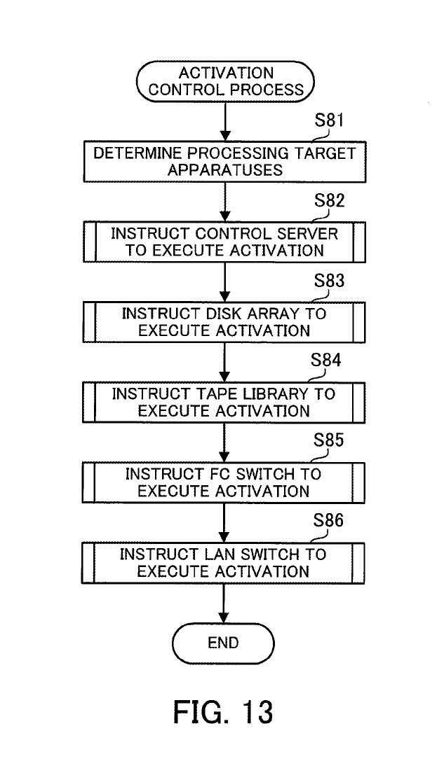

FIG. 13 is a flowchart illustrating an example of an activation control processing procedure. The update control unit 313 executes the process of FIG. 13 when instructed by the transfer processing unit 312 in step S43 of FIG. 10 to start an activation control process, or instructed by an input operation of the maintenance personnel to start an activation control process.

[Step S81] The update control unit 313 generates firmware activation information in the RAM 302. The update control unit 313 determines one or more apparatuses to be targets of the activation control process and registers the apparatus type and the apparatus ID of each of the determined apparatuses in the firmware activation information. More specifically, the update control unit 313 registers, in the firmware activation information, the apparatus type and the apparatus ID of each apparatus whose transfer necessity flag in the firmware transfer information 332 is “1”, that is, each apparatus that needs firmware transfer.

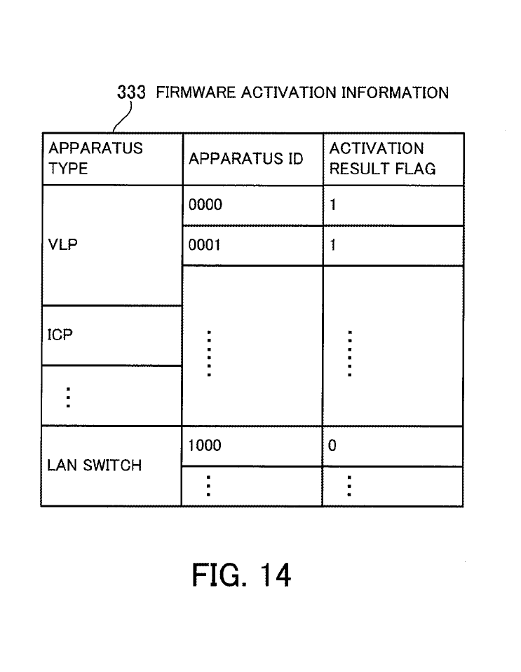

FIG. 14 illustrates an example of information registered in firmware activation information. In firmware activation information 333, each activation result flag is registered in association with an apparatus type and an apparatus ID. As described above, the apparatus type and the apparatus ID of each apparatus whose transfer necessity flag in the firmware transfer information 332 is “1” are registered in the firmware activation information 333.

The activation result flag is flag information indicating a result of an activation process in a corresponding apparatus. The activation process is a process in which the firmware update processing unit of the corresponding apparatus updates an activation result flag in the apparatus. The activation result flag being “1” indicates that the activation process in the corresponding apparatus has been completed successfully. The activation result flag being “0” indicates that the activation process in the corresponding apparatus has failed to be completed successfully.

Note that, after the activation control process of FIG. 13 is ended, the firmware activation information 333 is referenced by the update control unit 313 in a restart control process following the activation control process.

The description refers back to FIG. 13. The update control unit 313 executes a process of instructing the apparatuses registered in the firmware activation information 333 to execute an activation process, with respect to each apparatus type in a set order.

[Step S82] According to the transfer result flags in the firmware transfer information 332, corresponding to the control servers, the update control unit 313 determines one or more control servers for executing an activation process, and instructs each of the determined control servers to execute the activation process.

[Step S83] According to the transfer result flag in the firmware transfer information 332, corresponding to the disk array apparatus 200, the update control unit 313 determines whether to cause the disk array apparatus 200 to execute an activation process. In the case where the transfer result flag is “1”, the update control unit 313 instructs the disk array apparatus 200 to execute the activation process.

[Step S84] According to the transfer result flags in the firmware transfer information 332, corresponding to the tape library apparatuses, the update control unit 313 determines one or more tape library apparatuses for executing an activation process, and instructs each of the determined tape library apparatuses to execute the activation process.

[Step S85] According to the transfer result flags in the firmware transfer information 332, corresponding to the FC switches, the update control unit 313 determines one or more FC switches for executing an activation process, and instructs each of the determined FC switches to execute the activation process.

[Step S86] According to the transfer result flags in the firmware transfer information 332, corresponding to the LAN switches, the update control unit 313 determines one or more LAN switches for executing an activation process, and instructs each of the determined LAN switches to execute the activation process.

After completing the process of FIG. 13, the update control unit 313 executes a restart control process to be described later.

Next described is an activation instructing process performed with respect to each apparatus type. Assume here that, in this embodiment, the following conditions regarding a version of firmware to be run are provided for each apparatus type.

(Condition 1) Apparatuses of the same type have to run firmware of the same version. If multiple apparatuses of the same type run firmware with different versions, the firmware inconsistency may cause a malfunction in the apparatuses.

(Condition 2) If a firmware update is successfully completed in at least one of redundantly provided control servers of the same type, the service operation for accessing the virtual tape drive may be continued by causing only the control server with the successful update to operate.

(Condition 3) A firmware update has to be performed all together for control severs of different types, and the control servers of different types have to run firmware of the same version. If multiple control servers of different types run firmware of different versions, the firmware inconsistency may cause a malfunction in the control servers.

(Condition 4) An operational error due to firmware inconsistency does not occur between a non-control server apparatus and an apparatus whose type is different from that of the non-control server apparatus.

In this embodiment, as indicated in the above-described conditions, conditions for determining apparatuses for executing an activation process based on transfer result flags are different between the control servers and apparatuses other than the control servers (non-control server apparatuses).

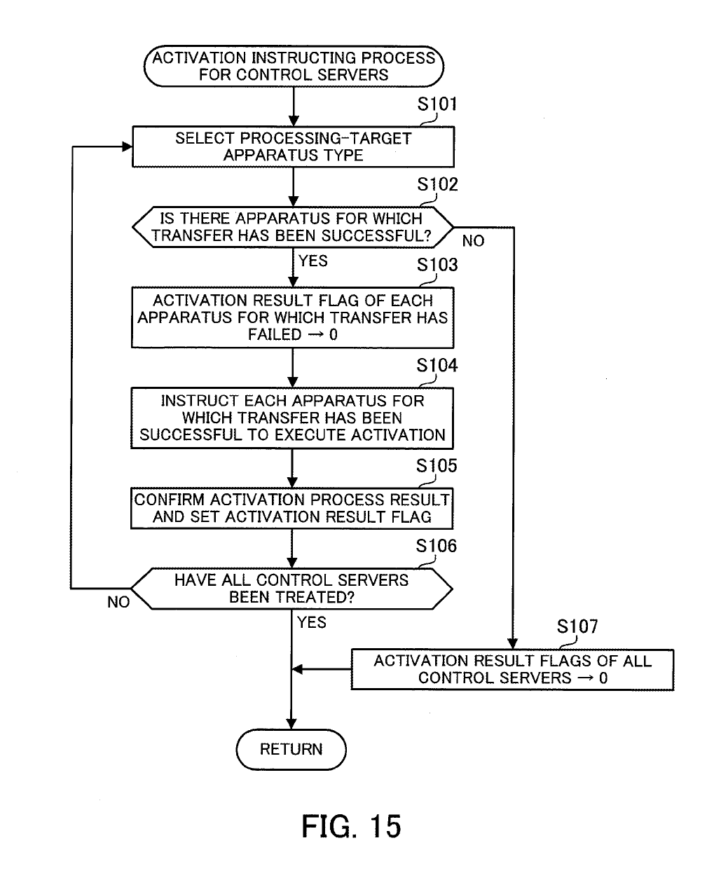

FIG. 15 is a flowchart illustrating an example of an activation instructing processing procedure for control servers. The process of FIG. 15 corresponds to step S82 of FIG. 13.

[Step S101] The update control unit 313 selects a processing-target apparatus type. Note that the update control unit 313 selects an apparatus type in the following order: “VLP”, “ICP”, “IDP”, and “PLP”.

[Step S102] The update control unit 313 reads, from the firmware transfer information 332, transfer result flags associated with apparatus IDs corresponding to the processing-target apparatus type, registered in the firmware activation information 333. If at least one of the read transfer result flags is “1”, that is, if the transfer process has been successful for at least one apparatus among apparatuses that need firmware transfer (S102: Yes), the update control unit 313 proceeds to step S103. On the other hand, if all the read transfer result flags are “0”, that is, if the transfer process has failed for all the apparatuses that need firmware transfer (S102: No), the update control unit 313 proceeds to step S107.

[Step S103] The update control unit 313 sets, to “0”, the activation result flag in the firmware activation information 333, corresponding to each apparatus whose transfer result flag read in step S102 is “0”, that is, each apparatus for which the firmware transfer process has failed.

[Step S104] The update control unit 313 instructs, to execute an activation process, the firmware update processing unit provided in each apparatus whose transfer result flag read in step S102 is “1”, that is, each apparatus for which the firmware transfer process has been successful. In response to the instruction, the firmware update processing unit updates the start-up flag in such a manner as to indicate one of the two firmware areas, different from the firmware area in which currently running firmware is stored.

[Step S105] The update control unit 313 confirms an activation process result with respect to each apparatus to which the execution of the activation process has been instructed. For example, the update control unit 313 receives information indicating whether the activation process has been successful, from the firmware update processing unit of the apparatus to which the execution of the activation process has been instructed. The update control unit 313 sets the activation result flag of each apparatus with a successful activation process to “1”, and sets the activation result flag of each apparatus with a failed activation process to “0”. Note that when determining that an apparatus instructed to execute an activation process has failed the activation process, the update control unit 313 may instruct the apparatus to execute an activation process once again, and set the activation result flag according to the retry result.

[Step S106] The update control unit 313 determines whether all the types of control servers have been selected as a processing target. If there is an apparatus type which has yet to be selected as a processing target (S106: No), the update control unit 313 returns to step S101 and selects a next apparatus type preliminarily determined as a processing target. On the other hand, if all the apparatus types have been selected as a processing target (S106: Yes), the update control unit 313 proceeds to step S83 of FIG. 13.

[Step S107] If the firmware transfer has failed for all the control servers of the processing-target apparatus type (S102: No), the update control unit 313 sets, to “0”, the activation result flags corresponding to all the control servers including apparatuses of the processing-target apparatus type. At this point, the update control unit 313 sets, to “0”, each activation result flag which has already been set to “1”.

As described later, each control server with the activation result flag being “0” is shut down and does not restart. Accordingly, if the firmware transfer has failed for all control servers of the same type, control servers of all types are shut down by the processing of step S107. With this, the above-described conditions (2) and (3) are satisfied.

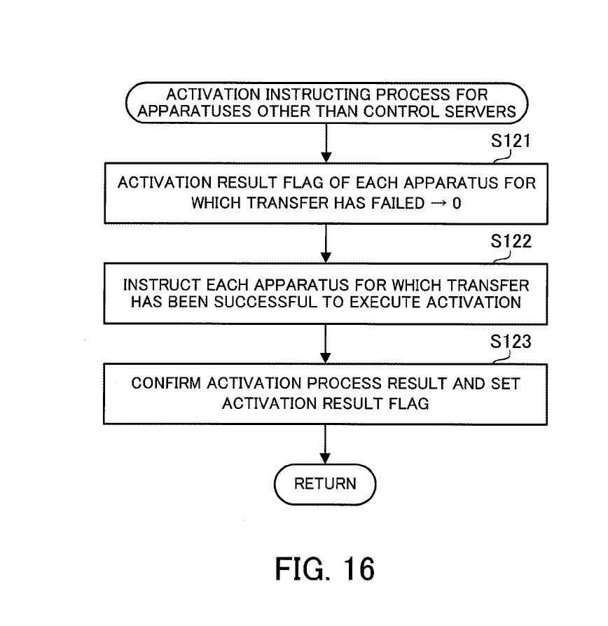

FIG. 16 is a flowchart illustrating an example of an activation instructing processing procedure for apparatuses other than control servers. The process of FIG. 16 corresponds to each of steps S83 to S86 of FIG. 13. That is, the update control unit 313 selects, as a processing target, one of the apparatus types of “disk array apparatus”, “tape library apparatus”, “FC switch”, and “LAN switch”, and executes the process of FIG. 16 for apparatuses of the selected processing-target apparatus type.

[Step S121] The update control unit 313 reads, from the firmware transfer information 332, transfer result flags associated with apparatus IDs corresponding to the processing-target apparatus type, registered in the firmware activation information 333. The update control unit 313 sets, to “0”, the activation result flag in the firmware activation information 333, corresponding to each apparatus whose transfer result flag is “0”, that is, each apparatus for which the firmware transfer process has failed.

[Step S122] The update control unit 313 instructs, to execute an activation process, the firmware update processing unit provided in each apparatus whose transfer result flag read in step S121 is “1”, that is, each apparatus for which the firmware transfer process has been successful. In response to the instruction, the firmware update processing unit updates the start-up flag in such a manner as to indicate one of the two firmware areas, different from the firmware area in which currently running firmware is stored.

[Step S123] In the same procedure as in step S105 of FIG. 15, the update control unit 313 confirms an activation process result with respect to each apparatus to which the execution of the activation process has been instructed. The update control unit 313 sets the activation result flag of each apparatus with a successful activation process to “1”, and sets the activation result flag of each apparatus with a failed activation process to “0”.

According to the process of FIG. 16 described above, for apparatuses other than the control servers, the activation result flag of each apparatus with a successful firmware transfer process is set to “1”, and the activation result flag of each apparatus with a failed firmware transfer process is set to “0”.

Next described is a restart control process performed by the update control unit 313. In the restart control process, conditions for determining apparatuses to be restarted based on activation result flags are different between the control servers and apparatuses other than the control servers (non-control server apparatuses) so as to satisfy the above-mentioned conditions (1) to (4).

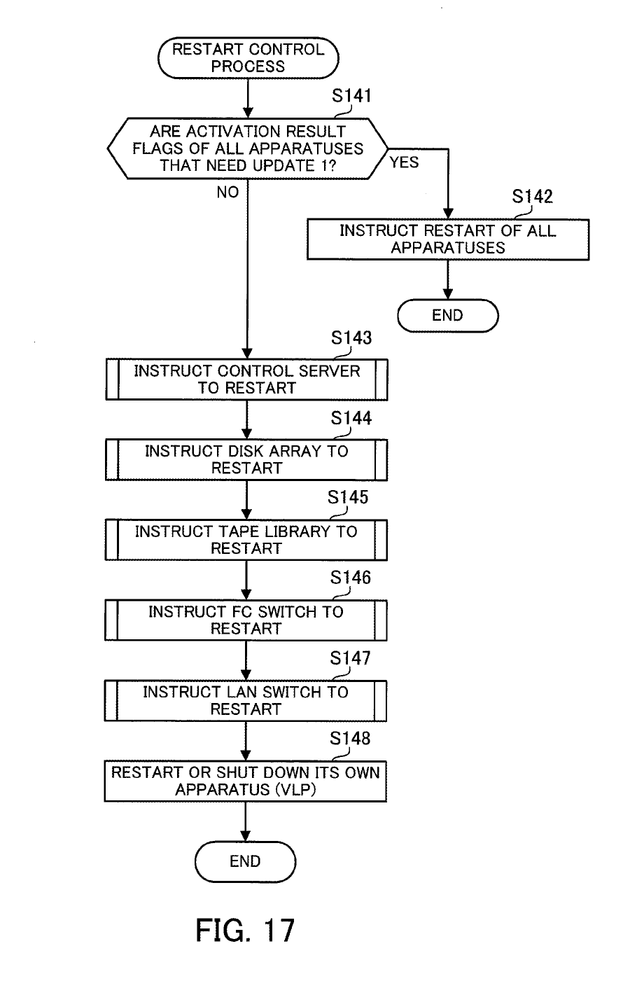

FIG. 17 is a flowchart illustrating an example of a restart control processing procedure. After ending the process of FIG. 13, the update control unit 313 subsequently executes the process of FIG. 17.

[Step S141] The update control unit 313 determines whether all activation result flags registered in the firmware activation information 333 are “1”. If all activation result flags are “1” (S141: Yes), the update control unit 313 proceeds to step S142. If there is at least one activation result flag being “0” (S141: No), the update control unit 313 proceeds to step S143.

[Step S142] The update control unit 313 instructs the firmware update processing unit of each of all the apparatuses registered in the firmware activation information 333 to restart its own apparatus, in other words, the apparatus to which the firmware update processing unit belongs. In response to the instruction, the firmware update processing unit resets and restarts its own apparatus. In addition, the update control unit 313 resets and restarts its own apparatus, that is, the VLP 300a if the VLP 300a is registered in the firmware activation information 333.

Note that, in step S142, the update control unit 313 may restart all apparatuses in the storage system. In this case, the update control unit 313 may instruct either one of the PCUs 600a and 600b (refer to FIG. 2) to execute restart. A PCU which has received the instruction stops power supply to all the apparatuses in the storage system and subsequently starts power supply again, to thereby cause all the apparatuses to restart.

On the other hand, if there is one or more activation result flags being “0” in the firmware activation information 333 (S141: No), the update control unit 313 proceeds to step S143. From step S143 onward, the update control unit 313 executes a process of restarting apparatuses registered in the firmware activation information 333, with respect to each apparatus type in a set order.

[Step S143] According to the activation result flags in the firmware activation information 333, corresponding to control servers, the update control unit 313 determines one or more control servers to be restarted, and causes the determined control servers to restart. Note however that the update control unit 313 excludes its own apparatus (that is, the VLP 300a) from the restart targets.

[Step S144] According to the activation result flag in the firmware activation information 333, corresponding to the disk array apparatus 200, the update control unit 313 determines whether to cause the disk array apparatus 200 to restart. When the activation result flag is “1”, the update control unit 313 causes the disk array apparatus 200 to restart.

[Step S145] According to the activation result flags in the firmware activation information 333, corresponding to tape library apparatuses, the update control unit 313 determines one or more tape library apparatuses to be restarted, and causes the determined tape library apparatuses to restart.

[Step S146] According to the activation result flags in the firmware activation information 333, corresponding to FC switches, the update control unit 313 determines one or more FC switches to be restarted, and causes the determined FC switches to restart.

[Step S147] According to the activation result flags in the firmware activation information 333, corresponding to LAN switches, the update control unit 313 determines one or more LAN switches to be restarted, and causes the determined LAN switches to restart.

[Step S148] The update control unit 313 resets and restarts its own apparatus (that is, the VLP 300a) if the activation result flag corresponding to the VLP 300a in the firmware activation information 333 is “1”. Note that, for example, the update control unit 313 records information indicating a firmware update status of each apparatus, in the HDD 303 of the VLP 300a before the reset. The information indicating the update status includes, for example, information for identifying, among the apparatuses to be subjected to a firmware update, each apparatus which has or has not executed the restart process. By recording such information in the HDD 303, the update control unit 313 is able to, for example, cause the display 304a to display firmware update statuses after the restart operation, to thereby notify the maintenance personnel of the firmware update statuses.

On the other hand, the update control unit 313 shuts down its own apparatus (the VLP 300a) if the activation result flag corresponding to the VLP 300a is “0”. In this case, after causing the display 304a to display the above-mentioned firmware update statuses, the update control unit 313 may shut down the VLP 300a according to an instruction input from the maintenance personnel.

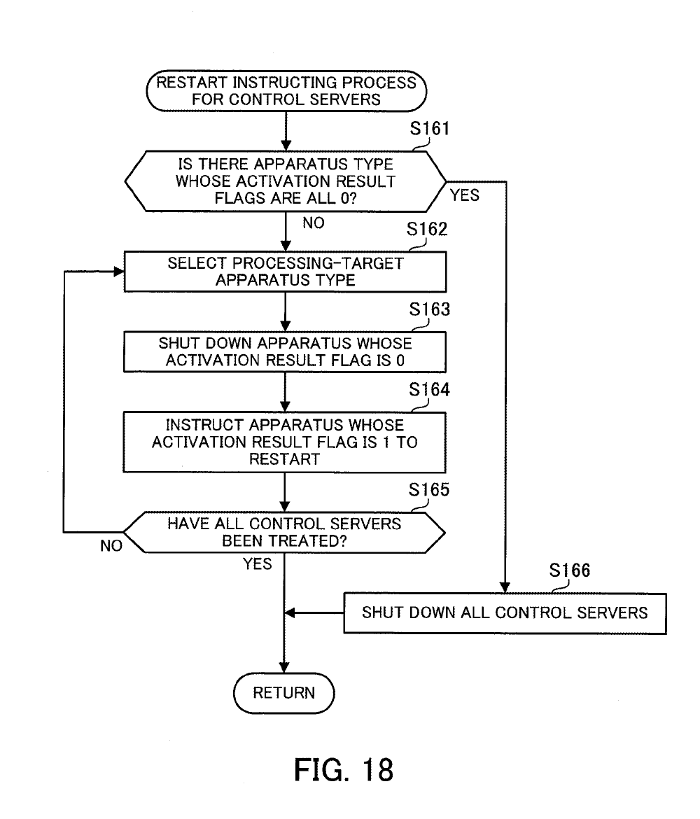

FIG. 18 is a flowchart illustrating an example of a restart instructing processing procedure for control servers. The process of FIG. 18 corresponds to step S143 of FIG. 17.

[Step S161] The update control unit 313 reads, from the firmware activation information 333, activation result flags associated with control servers with respect to each apparatus type. The update control unit 313 determines whether there is an apparatus type whose associated activation result flags are all “0”. If there is no apparatus type whose associated activation result flags are all “0”, that is, if, for each of all the apparatus types, the activation process has been successful in at least one of control servers to be subjected to a firmware update (S161: No), the update control unit 313 proceeds to step S162. On the other hand, if there is an apparatus type whose associated activation result flags are all “0”, that is, if the activation process has failed in all control servers of the same type to be subjected to a firmware update (S161: Yes), the update control unit 313 proceeds to step S166.

[Step S162] The update control unit 313 selects a processing-target apparatus type. Note that the update control unit 313 selects an apparatus type in the following order: “VLP”, “ICP”, “IDP”, and “PLP”.

[Step S163] Based on the firmware activation information 333, the update control unit 313 determines each apparatus ID whose activation result flag is “0” among apparatus IDs of the apparatus type selected as a processing target. The update control unit 313 instructs the firmware update processing unit of an apparatus corresponding to each of the determined apparatus IDs to shut down its own apparatus. In response to the instruction, the firmware update processing unit shuts down its own apparatus. Note however that the update control unit 313 does not shut down its own apparatus (that is, the VLP 300a).

[Step S164] Based on the firmware activation information 333, the update control unit 313 determines each apparatus ID whose activation result flag is “1” among apparatus IDs of the apparatus type selected as a processing target. The update control unit 313 instructs the firmware update processing unit of an apparatus corresponding to each of the determined apparatus IDs to restart its own apparatus. In response to the instruction, the firmware update processing unit resets and restarts its own apparatus. Note however that the update control unit 313 does not restart its own apparatus (that is, the VLP 300a).

By steps S163 and S164 above, the above-described conditions (1) and (2) are satisfied for control servers of the same type.

[Step S165] The update control unit 313 determines whether all the types of control servers have been selected as a processing target. If there is an apparatus type which has yet to be selected as a processing target (S165: No), the update control unit 313 returns to step S162 and selects a next apparatus type preliminarily determined as a processing target. On the other hand, if all the apparatus types have been selected as a processing target (S165: Yes), the update control unit 313 proceeds to step S144 of FIG. 17.

[Step S166] If activation result flags corresponding to all the control servers of the processing-target apparatus type are “0” (S161: Yes), the update control unit 313 instructs the firmware update processing unit of each of all the control servers including apparatuses of the processing-target apparatus type to shut down its own apparatus. In response to the instruction, the firmware update processing unit shuts down its own apparatus. With this processing, the above-described conditions (2) and (3) are satisfied for the control servers. Note however that the update control unit 313 does not shut down its own apparatus (that is, the VLP 300a), and shuts down the VLP 300a in step S148 of FIG. 17.

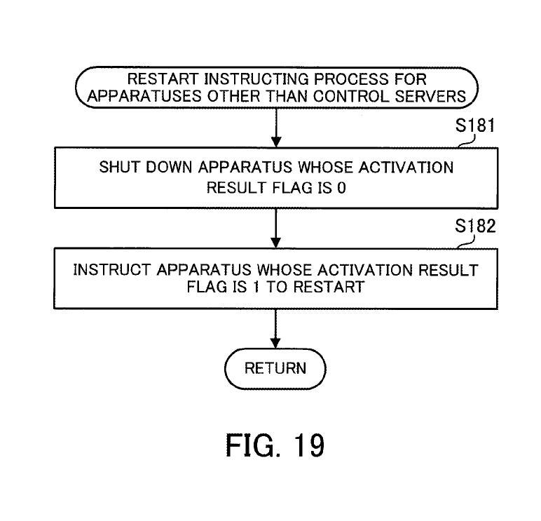

FIG. 19 is a flowchart illustrating a restart instructing processing procedure for apparatuses other than control servers. The process of FIG. 19 corresponds to each of steps S144 to S147 of FIG. 17. That is, the update control unit 313 selects, as a processing target, one of the apparatus types of “disk array apparatus”, “tape library apparatus”, “FC switch”, and “LAN switch”, and executes the process of FIG. 19 for apparatuses of the selected processing-target apparatus type.

[Step S181] The update control unit 313 reads, from the firmware activation information 333, activation result flags associated with apparatus IDs corresponding to the processing-target apparatus type. The update control unit 313 instructs the firmware update processing unit of each apparatus whose read activation result flag is “0” to shut down its own apparatus. In response to the instruction, the firmware update processing unit shuts down its own apparatus.

[Step S182] The update control unit 313 instructs the firmware update processing unit of each apparatus whose activation result flag read in step S181 is “1” to restart its own apparatus. In response to the instruction, the firmware update processing unit resets and restarts its own apparatus.

By steps S181 and S182 above, the above-described conditions (1) and (4) are satisfied for apparatuses of the same type, other than the control servers.

By the above-described processes of the transfer processing unit 312 and the update control unit 313, whether to update firmware to be run on an apparatus or shut down the apparatus is determined based on the firmware transfer result and the activation process result according to conditions set for each apparatus type. This allows restart of the service operation for accessing the virtual tape drive while satisfying the above-described conditions (1) to (4), which reduces the possibility of occurrence of malfunction after the restart of the service operation.

In addition, the VLP 300a automatically determines whether to update firmware to be run on an apparatus or shut down the apparatus. This reduces the workload of the maintenance personnel when a large number of apparatuses are included in the storage system, and also reduces the time to be taken for the firmware update. In addition, it is possible to reduce the operation stop time of the service for accessing the virtual tape drive.

Note that, in step S163 of FIG. 18 and step S181 of FIG. 19, for example, each apparatus whose activation result flag is “0” is shut down. However, for example, in the case where an error due to firmware inconsistency does not occur even when multiple apparatuses of the same type run firmware with different versions, the shutdown may not be executed in each of these steps S163 and S181. In this case, apparatuses for which firmware transfer has failed, or apparatuses for which firmware transfer has been successful but firmware activation has failed, keep operating without change of firmware to be run. In this case, it is possible to maintain redundancy of apparatuses of the same type.

On the other hand, it is highly likely that apparatuses for which firmware transfer or activation has failed have an internal error. Accordingly, not only when such an apparatus is restarted and keeps being used but also when the apparatus keeps being used without a restart, the apparatus may operate in an unstable manner. The update control unit 313 shuts down such apparatuses, to thereby stabilize the operation of the entire system.

In addition, the above-described processing functions of individual apparatuses, such as the control servers, described in each of the embodiments above may be achieved by a computer. In this case, a program is provided in which processing contents of functions that each communication apparatus needs to have are described. By executing the program on the computer, the above-described processing functions are achieved on the computer. The program in which processing contents are described may be recorded in a computer-readable recording medium. Such computer-readable recording media include a magnetic-storage device, an optical disk, a magneto-optical recording medium, and a semiconductor memory. Examples of the magnetic-storage device are a hard disk drive (HDD), a flexible disk (FD), and a magnetic tape. Examples of the optical disk are a digital versatile disk (DVD), a DVD random access memory (DVD-RAM), a compact disc read-only memory (CD-ROM), a CD recordable (CD-R), and a CD rewritable (CD-RW). An example of the magneto-optical recording medium is a magneto-optical disk (MO).

In the case of distributing the program, portable recording media, such as DVDs and CD-ROMs, in which the program is recorded are sold. In addition, the program may be stored in a memory device of a server computer and then transferred from the server computer to another computer via a network.

A computer for executing the program stores the program, which is originally recorded in a portable recording medium or transferred from the server computer, in its own memory device. Subsequently, the computer reads the program from its own memory device and performs processing according to the program. Note that the computer is able to read the program directly from the portable recording medium and perform processing according to the program. In addition, the computer is able to sequentially perform processing according to a received program each time such a program is transferred from the server computer connected via the network.

According to one aspect, in a control apparatus, a control system, and a control method, it is possible to reduce the possibility of failure occurrence in an electronic apparatus due to a program update.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A control apparatus for performing control to update a program for each of a plurality of electronic apparatuses, comprising:
a transfer control unit configured to acquire a version number of the program from each of the plurality of electronic apparatuses and transfer an update program according to the acquired version number to one or more of the plurality of electronic apparatuses; and
an update control unit configured to acquire, from the one or more of the plurality of electronic apparatuses, information regarding whether the transfer of the update program by the transfer control unit has been completed successfully, and output, to one or more electronic apparatuses for which the transfer of the update program by the transfer control unit has been completed successfully, an instruction for executing an update process to make a change to the update program transferred by the transfer control unit.

2. The control apparatus according to claim 1, wherein
the update control unit outputs an instruction for shutting down one or more electronic apparatuses for which the transfer of the update program by the transfer control unit has not been completed successfully.

3. The control apparatus according to claim 1, wherein
when the transfer of the update program by the transfer control unit has not been completed successfully for all electronic apparatuses of a first type among the plurality of electronic apparatuses, the update control unit outputs
an instruction for shutting down all the electronic apparatuses of the first type, and
an instruction for shutting down all electronic apparatuses of a predetermined second type among the plurality of electronic apparatuses.

4. The control apparatus according to claim 3, wherein
when the transfer of the update program by the transfer control unit has been completed successfully for at least one of the electronic apparatuses of the first type and the transfer of the update program by the transfer control unit has been completed successfully for at least one of the electronic apparatuses of the second type, the update control unit outputs
an instruction for causing the at least one of the electronic apparatuses of the first type and the at least one of the electronic apparatuses of the second type to individually execute the update process and
an instruction for shutting down one or more of the electronic apparatuses of the first type and one or more of the electronic apparatuses of the second type for which the transfer of the update program has not been completed successfully.

5. The control apparatus according to claim 1, wherein
the update process includes
a program activation process in which each of the one or more of the plurality of electronic apparatuses, to which the update program has been transferred, overwrites program designation information indicating a program to be run after a restart in such a manner that the program designation information indicates the update program transferred by the transfer control unit, and
a restart process in which each of the one or more of the plurality of electronic apparatuses, to which the update program has been transferred, restarts, and
the update control unit excludes, from electronic apparatuses caused to execute the restart process, the one or more electronic apparatuses for which the transfer of the update program by the transfer control unit has not been completed successfully and one or more electronic apparatuses for which the program activation process has not been completed successfully.

6. The control apparatus according to claim 5, wherein
the update control unit causes one or more electronic apparatuses for which both the transfer of the update program by the transfer control unit and the program activation process have been completed successfully to execute the restart process.

7. The control apparatus according to claim 1, further comprising:
a firmware storing processing unit configured to read, from a portable storage medium, firmware for each of a plurality of types of the plurality of electronic apparatuses and store the firmware in a predetermined firmware storage area,
wherein the transfer control unit reads the firmware from the firmware storage area and transfers the firmware to one or more of the plurality of electronic apparatuses caused to run the firmware.

8. The control apparatus according to claim 7, wherein
the firmware storage area is provided in a storage device included in one of the plurality of electronic apparatuses.

9. A control system comprising:
a plurality of electronic apparatuses; and
a control apparatus configured to perform control to update a program for each of the plurality of electronic apparatuses,
wherein the control apparatus includes
a transfer control unit configured to acquire a version number of the program from each of the plurality of electronic apparatuses and transfer an update program according to the acquired version number to one or more of the plurality of electronic apparatuses, and
an update control unit configured to acquire, from the one or more of the plurality of electronic apparatuses, information regarding whether the transfer of the update program by the transfer control unit has been completed successfully, and output, to one or more electronic apparatuses for which the transfer of the update program by the transfer control unit has been completed successfully, an instruction for executing an update process to make a change to the update program transferred by the transfer control unit.

10. The control system according to claim 9, wherein
the update control unit outputs an instruction for shutting down one or more electronic apparatuses for which the transfer of the update program by the transfer control unit has not been completed successfully.

11. The control system according to claim 9, wherein
when the transfer of the update program by the transfer control unit has not been completed successfully for all electronic apparatuses of a first type, the update control unit outputs
an instruction for shutting down all the electronic apparatuses of the first type and
an instruction for shutting down all electronic apparatuses of a predetermined second type.

12. The control system according to claim 11, wherein
when the transfer of the update program by the transfer control unit has been completed successfully for at least one of the electronic apparatuses of the first type and the transfer of the update program by the transfer control unit has been completed successfully for at least one of the electronic apparatuses of the second type, the update control unit outputs
an instruction for causing the at least one of the electronic apparatuses of the first type and the at least one of the electronic apparatuses of the second type to individually execute the update process and
an instruction for shutting down one or more of the electronic apparatuses of the first type and one or more of the electronic apparatuses of the second type for which the transfer of the update program has not been completed successfully.

13. A control method for a control apparatus that performs control to update a program for each of a plurality of electronic apparatuses, the control method comprising:
acquiring a version number of the program from each of the plurality of electronic apparatuses;
transferring an update program according to the acquired version number to one or more of the plurality of electronic apparatuses;
acquiring, from the one or more of the plurality of electronic apparatuses, information regarding whether the transfer of the update program has been completed successfully; and
outputting, to one or more electronic apparatuses for which the transfer of the update program has been completed successfully, an instruction for executing an update process to make a change to the transferred update program.

14. The control method according to claim 13, wherein
in the outputting, an instruction for shutting down one or more electronic apparatuses for which the transfer of the update program has not been completed successfully is output.

15. The control method according to claim 13, wherein
in the outputting, when the transfer of the update program has not been completed successfully for all electronic apparatuses of a first type among the plurality of electronic apparatuses, a first instruction and a second instruction are output, the first instruction indicating to shut down all the electronic apparatuses of the first type, and the second instruction indicating to shut down all electronic apparatuses of a predetermined second type among the plurality of electronic apparatuses.

16. The control method according to claim 15, wherein
in the outputting, when the transfer of the update program has been completed successfully for at least one of the electronic apparatuses of the first type and the transfer of the update program has been completed successfully for at least one of the electronic apparatuses of the second type, a third instruction and a fourth instruction are output, the third instruction indicating to cause the at least one of the electronic apparatuses of the first type and the at least one of the electronic apparatuses of the second type to individually execute the update process, and the fourth instruction indicating to shut down one or more of the electronic apparatuses of the first type and one or more of the electronic apparatuses of the second type for which the transfer of the update program has not been completed successfully.

17. The control method according to claim 13, wherein
the update process includes
a program activation process in which each of the one or more of the plurality of electronic apparatuses, to which the update program has been transferred, overwrites program designation information indicating a program to be run after a restart in such a manner that the program designation information indicates the update program transferred from the control apparatus, and
a restart process in which each of the one or more of the plurality of electronic apparatuses, to which the update program has been transferred, restarts, and
in the outputting, the one or more electronic apparatuses for which the transfer of the update program has not been completed successfully and one or more electronic apparatuses for which the program activation process has not been completed successfully are excluded from electronic apparatuses caused to execute the restart process.

18. The control method according to claim 17, wherein
in the outputting, one or more electronic apparatuses for which both the transfer of the update program and the program activation process have been completed successfully are caused to execute the restart process.

19. The control method according to claim 13, further comprising
reading, from a portable storage medium, firmware for each of a plurality of types of the plurality of electronic apparatuses and storing the firmware in a predetermined firmware storage area,
wherein in the outputting, the firmware is read from the firmware storage area, and the read firmware is transferred to one or more of the plurality of electronic apparatuses caused to run the firmware.

20. The control method according to claim 19, wherein
the firmware storage area is provided in a storage device included in one of the plurality of electronic apparatuses.
